(19) United States
(12) Patent Application Publication
(10) Pub. No.: US 2026/0107039 A1
(43) Pub. Date: Apr. 16, 2026

(54) ELECTRONIC APPARATUS AND METHOD OF OPERATING THE ELECTRONIC APPARATUS

(71) Applicant: Samsung Electronics Co., Ltd., Suwon-si (KR)

(72) Inventor: Juhyun CHOI, Suwon-si (KR)

(21) Appl. No.: 19/282,879

(22) Filed: Jul. 28, 2025

Related U.S. Application Data
(63) Continuation of application No. PCT/KR2025/095404, filed on Jun. 12, 2025.

(30) Foreign Application Priority Data
Oct. 15, 2024 (KR) 10-2024-0140542

(51) Int. Cl. H04N 21/462; A63F 13/40; H04N 21/422; H04N 21/436; H04W 4/80; H04W 76/20

(52) U.S. Cl. CPC H04N 21/4622; A63F 13/40; H04N 21/42221; H04N 21/42225; H04N 21/43615; H04W 4/80; H04W 76/20

(57) ABSTRACT

An electronic apparatus includes a communication interface, an input/output interface, memory storing at least one instruction, and at least one processor including processing circuitry, wherein at least one processor individually or collectively, executes the at least one instruction to cause the electronic apparatus to: wirelessly connect to a control device through the communication interface, obtain an input for switching an input source of the electronic apparatus from an internal source of the electronic apparatus to a first external device, and transmit, to a control device wirelessly connected to the electronic apparatus, through the communication interface based on the input, a termination connection request including a connection termination reason including identification information of the first external device.

### CROSS-REFERENCE TO RELATED APPLICATIONS

This application is a continuation of International Application No. PCT/KR2025/095404 designating the United States, filed on Jun. 12, 2025, in the Korean Intellectual Property Receiving Office and claiming priority to Korean Patent Application No. 10-2024-0140542, filed on Oct. 15, 2024, in the Korean Intellectual Property Office, the disclosures of each of which are incorporated by reference herein in their entireties.

### BACKGROUND

### Field

The disclosure relates to an electronic apparatus and a method of operating the electronic apparatus. For example, the disclosure relates to an electronic apparatus in which connection of a control device may be smoothly switched between a plurality of devices and a method of operating the electronic apparatus.

### Description of Related Art

An electronic apparatus may be operated by being connected to various control devices or external devices. For example, a user may operate the electronic apparatus using a control device. In addition, an external device may be set as an input source of the electronic apparatus.

The input source of the electronic apparatus may be set to an internal source of the electronic apparatus or to an external device. When the input source of the electronic apparatus is set to an internal source, the user may operate the electronic apparatus using a control device connected to the electronic apparatus.

However, when the input source of the electronic apparatus is switched from an internal source of the electronic apparatus to an external device, in some cases, the user must manually terminate the connection between the electronic apparatus and the control device to operate the external device using the control device which was connected to the electronic apparatus. In this case, the user must manually connect the control device to the external device, which may cause inconvenience such as frequent connection failures.

### SUMMARY

Embodiments of the disclosure provide an electronic apparatus in which connection switching of a control device between a plurality of devices is facilitated and a method of operating the electronic apparatus.

The electronic apparatus according to an example embodiment of the disclosure may include: a communication interface, comprising communication circuitry, an input/output interface, comprising circuitry, memory storing at least one instruction, and at least one processor comprising processing circuitry. At least one processor individually or collectively, may be execute the at least one instruction to cause the electronic apparatus to: wirelessly connect to a control device through the communication interface; obtain an input for switching an input source of the electronic apparatus from an internal source of the electronic apparatus to a first external device; and transmit, to the control device wirelessly connected to the electronic apparatus, based on the input, a termination connection request including a connection termination reason including identification information of the first external device, wherein connection termination reason may enable the control device which has received the termination connection request, to perform a connection operation with the first external device using identification information of the first external device included in the connection termination reason.

A method of operating the electronic apparatus, according to an example embodiment of the disclosure, may include: wirelessly connecting to a control device through a communication interface; obtaining an input for switching an input source of the electronic apparatus from an internal source of the electronic apparatus to a first external device; and transmitting, to the control device, connected to the electronic apparatus, based on the input, a termination connection request including a connection termination reason including identification information of the first external device, wherein the connection termination reason may enable the control device, which has received the termination connection request, to perform a connection operation with the first external device using the identification information of the first external device included in the connection termination reason.

According to an example embodiment of the disclosure, a non-transitory computer-readable recording medium containing at least one instruction that, when executed by at least one processor, comprising processing circuitry, individually or collectively, of an electronic apparatus, may cause the electronic apparatus to: wirelessly connect to a control device through the communication interface, obtain an input for switching an input source of the electronic apparatus from an internal source of the electronic apparatus to a first external device, and transmit, to a control device wirelessly connected to the electronic apparatus, based on the input, a termination connection request including a connection termination reason including identification information of the first external device, wherein the connection termination reason enables the control device, which has received the termination connection request, to perform a connection operation with the first external device using the identification information of the first external device included in the connection termination reason.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of a system for switching connection of a control device between a plurality of electronic apparatuses, according to various embodiments;

FIG. 2 is a block diagram an example configuration of a system including an electronic apparatus, a control device, and an external device according to various embodiments;

FIG. 3 is a block diagram illustrating an example configuration of a system including an electronic apparatus, a control device, and an external device according to various embodiments;

FIG. 4 is a block diagram illustrating an example configuration of an electronic apparatus according to various embodiments;

FIG. 5 is a flowchart illustrating an example method of operating an electronic apparatus, according to various embodiments;

FIG. 6 is a signal flow diagram illustrating an example operating method between an electronic apparatus, a control device, and an external device, according to various embodiments;

FIG. 7 is a signal flow diagram illustrating an example operating method between an electronic apparatus, a control device, and an external device, according to various embodiments;

FIG. 8 is a signal flow diagram illustrating an example operating method between an electronic apparatus, a control device, and an external device, according to various embodiments;

FIG. 9 is a diagram illustrating an example in which an electronic apparatus directly controls a second external device, according to various embodiments;

FIG. 10 is a signal flow diagram illustrating an example operating method between an electronic apparatus, a control device, and a second external device, according to various embodiments;

FIG. 11 is a diagram illustrating an example process in which an electronic apparatus, a control device, an external device, and a server perform operations, according to various embodiments;

FIG. 12 is a diagram illustrating an example process in which an electronic apparatus obtains an input for switching an input source through a user interface provided by an external device, according to various embodiments;

FIG. 13 is a diagram illustrating an example process in which an electronic apparatus obtains an input for switching an input source through an interface provided by the electronic apparatus, according to various embodiments; and

FIG. 14 is a diagram illustrating an example process in which an electronic apparatus obtains an input for switching an input source from a server which has obtained a user input from a smart device, according to various embodiments.

### DETAILED DESCRIPTION

It should be understood that the various example embodiments of the disclosure and the terms used herein are not intended to limit the technical features described in the disclosure to specific embodiments, but to include various modifications, equivalents, or alternatives of corresponding embodiments.

In relation to the description of drawings, like reference numerals may denote like or related elements.

The singular form of a noun corresponding to an item may include one or more of the item, unless the context clearly indicates otherwise.

In the disclosure, each of the phrases “A or B”, “at least one of A and B”, “at least one of A or B”, “A, B, or C”, “at least one of A, B, and C”, and “at least one of A, B, or C” may include any one of the items listed together in that phrase, or any possible combinations thereof.

The term “and/or” includes any combination of a plurality of related described elements or any one of a plurality of related described elements.

Terms, such as “first”, “second”, or “first” or “second” may be used merely to distinguish one element from another corresponding element, and do not limit the elements in any other respect (e.g., importance or order).

When an (e.g., first) element is referred to as being “coupled” or “connected” to another (e.g., second) element, with or without the terms “functionally” or “communicatively”, the element may be connected to the other element directly (e.g., through cable), wirelessly, or through a third element.

The terms “include” or “have” are intended to specify the presence of a feature, number, step, operation, element, component, or combination thereof described in the disclosure, but do not exclude the presence or addition of one or more other features, numbers, steps, operations, elements, components, or combinations thereof.

When an element is described to be “connected to”, “coupled to”, “supported by”, or “in contact with” another element, it includes not only cases where the elements are directly connected, coupled, supported, or in contact, but also cases where the elements are indirectly connected, coupled, supported, or in contact through a third element.

When it is described that an element is located “on” another element, it includes not only cases where the element is in contact with the other element, but also cases where another element exists between the two elements.

It should be understood that blocks in each flowchart and any combinations of flowcharts may be performed by one or more computer programs including computer-executable instructions. The one or more computer programs may be entirely stored in a single memory, or may be split across a plurality of different memories.

The term “user” may refer to a person who controls a function or operation of a computing device or electronic apparatus using a control device, and may include a viewer, a game player, an administrator, or an installation technician.

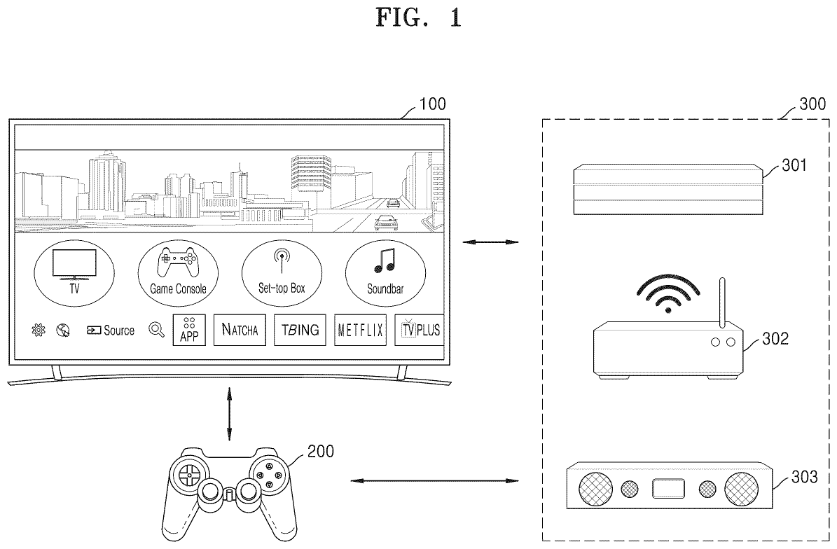

FIG. 1 is a diagram illustrating an example of a system for switching connection of a control device between a plurality of electronic apparatuses, according to various embodiments.

Referring to FIG. 1, the system may include an electronic apparatus 100, a control device 200, and an external device 300. In an embodiment of the disclosure, the electronic apparatus 100 may be connected to the control device 200 and/or the external device 300. In an embodiment of the disclosure, the control device 200 may be connected to the electronic apparatus 100 and/or the external device 300. In an embodiment of the disclosure, the external device 300 may be connected to the electronic apparatus 100 and/or the control device 200.

The external device 300 may be connected to the electronic apparatus 100, may transmit data to the electronic apparatus 100 and receive data from the electronic apparatus 100. The external device 300 may include one or more external devices, e.g., a first external device 301, a second external device 302, and a third external device 303. In an embodiment of the disclosure, the first external device 301 may be a game console, the second external device 302 may be a set-top box, and the third external device 303 may be a sound bar, but an embodiment of the disclosure is not limited thereto. The first external device 301, the second external device 302, and the third external device 303 may be a same type of device, different devices, or devices which operate in combination with each other. In the disclosure, for convenience of explanation, the first external device 301 or the second external device 302 may be used to describe an embodiment of the external device 300, but the disclosure is not limited thereto.

The electronic apparatus 100 may be connected to the control device 200 and may transmit and receive data to and from the control device 200. For example, the electronic apparatus 100 may be connected to the control device 200 according to a wireless communication protocol and may transmit and receive data. The control device 200 may be connected to the electronic apparatus 100 according to a wireless communication protocol and may transmit and receive data. For example, the wireless communication protocol may include, but is not limited to, Bluetooth communication protocols, Wireless Fidelity (Wi-Fi) communication protocols, Bluetooth Low Energy (BLE) communication protocols, Near-Field Communication (NFC)/Radio-Frequency Identification (RFID) communication protocols, Wi-Fi Direct communication protocols, Ultra-Wideband (UWB) communication protocols, ZigBee communication protocols, Long Range (LoRa) communication protocols, or the like.

The electronic apparatus 100 may be connected to the external device 300 and may transmit and receive data to and from the external device 300. The electronic apparatus 100 may be connected to the external device 300 through an interface port or wireless communication protocol and may transmit and receive data to and from the external device 300. The external device 300 may be connected to the electronic apparatus 100 through an interface port or wireless communication protocol and may transmit and receive data to and from the electronic apparatus 100. For example, the interface port may include, but is not limited to, a High-Definition Multimedia Interface (HDMI) port, a component jack, a personal computer (PC) port, a Universal Serial Bus (USB) port, an Ethernet port, a Display Port, an Audio Return Channel (ARC)/Enhanced Audio Return Channel (eARC) protocol, or the like.

The electronic apparatus 100 may be wirelessly connected to the control device 200 through a communication interface. An embodiment of a connection operation between the electronic apparatus 100 and the control device 200 is described in greater detail below.

For example, in order to be connected to the control device 200 according to the Bluetooth communication protocol and to transmit and receive data, the electronic apparatus 100 may perform a pairing operation and/or a connection operation with the control device 200. In addition, in order for the control device 200 and the external device 300 to be connected according to the Bluetooth communication protocol and to transmit and receive data, the control device 200 and the external device 300 may perform a pairing operation and/or a connection operation.

For example, in order for the electronic apparatus 100 to establish connection with the control device 200 according to the Wi-Fi communication protocol and transmit and receive data, the electronic apparatus 100 may be connected to the same wireless network as the control device 200. The electronic apparatus 100 may manage a connection status of the control device 200. The electronic apparatus 100 may obtain an input signal of the control device 200. For example, a service daemon of the electronic apparatus 100 may manage the connection status of the control device 200. The service daemon of the electronic apparatus 100 may obtain an input signal of the control device 200.

In an embodiment of the disclosure, the electronic apparatus 100 may load a driver suitable for the connected control device 200. For example, a control device driver of the electronic apparatus 100 may load the driver suitable for the connected control device 200. The electronic apparatus 100 may transmit and receive data to and from the control device 200 using the driver suitable for the control device 200. In an embodiment of the disclosure, the control device 200 and the external device 300 may transmit and receive data by being connected to a network through the same connection method of the electronic apparatus 100 described above.

For example, while the electronic apparatus 100 and the control device 200 are connected and the control device 200 is performing an operation to control the electronic apparatus 100, in some cases, the electronic apparatus 100 may obtain an input for switching an input source of the electronic apparatus 100 to the first external device 301. In this case, in order for a user to control (or operate) the first external device 301 using the control device 200, the user may need to terminate the connection between the electronic apparatus 100 and the control device 200 and perform an operation to pair and/or connect (or retrieve and/or connect) the control device 200 and the first external device 301.

For example, it is assumed that the electronic apparatus 100 is a television (TV), the control device 200 is a game pad, and the first external device 301 is a game console. However, it will be understood that the disclosure is not so limited. In some cases, the user is playing a game built into the TV using the game pad connected to the TV through Bluetooth communication, and then wants to play a game on the game console. In this case, the user may switch an input source of the TV from an internal source of the TV to the game console. In this case, in order to control the game console using the game pad, it may be necessary to terminate the connection between the game pad and the TV, and then operate the game pad to connect the game pad to the game console.

According to an embodiment disclosed in the disclosure, a method may be provided for switching, without user intervention, a device to which a control device is connected, when an input source of the electronic apparatus 100 is switched. According to an embodiment, a method of sequentially connecting a control device between a plurality of electronic apparatuses may be provided. According to an embodiment, an electronic apparatus connected to a control device may be switched more simply and easily.

Hereinbelow, an example is described in which the input source of the electronic apparatus 100 is switched from an internal source of the electronic apparatus 100 to the external device 300. In the description below, for convenience of description, the first external device 301 is described as an example of the external device 300, but the disclosure is not limited thereto.

According to an embodiment of the disclosure, the electronic apparatus 100 may obtain an input for switching an input source of the electronic apparatus 100 from an internal source of the electronic apparatus 100 to the first external device 301.

According to an embodiment of the disclosure, the electronic apparatus 100 may provide a user interface for obtaining an input for switching the input source of the electronic apparatus 100. The electronic apparatus 100 may obtain, based on an input (e.g., a user input) received through the user interface, an input for switching the input source of the electronic apparatus 100 from the internal source of the electronic apparatus 100 to the first external device 301.

According to an embodiment of the disclosure, the electronic apparatus 100 may transmit, to the control device 200 connected to the electronic apparatus, a termination connection request including a connection termination reason including identification information of the first external device 301, based on the input. The termination connection request may refer, for example, to a message sent to terminate or release a connection between the electronic apparatus 100 and the control device 200 or between the first external device 301 and the control device 200.

According to an embodiment of the disclosure, the connection termination reason may enable the control device 200, which has received the termination connection request, to perform a connection operation with the first external device 301 using the identification information of the first external device 301 included in the connection termination reason. According to an embodiment of the disclosure, in response to receiving the termination connection request, the control device 200 may perform a connection operation with the first external device 301 using the identification information of the first external device 301 included in the connection termination reason.

According to an embodiment of the disclosure, in response to the termination connection request, the electronic apparatus 100 may receive a connection termination response from the control device 200. According to an embodiment of the disclosure, the connection between the electronic apparatus 100, which has received the connection termination response, and the control device 200 may be terminated.

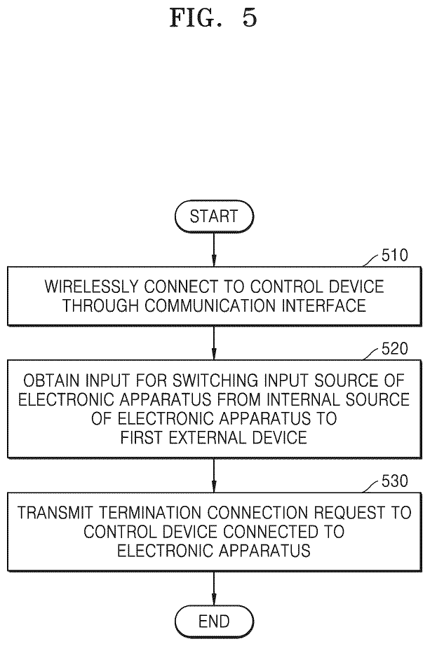

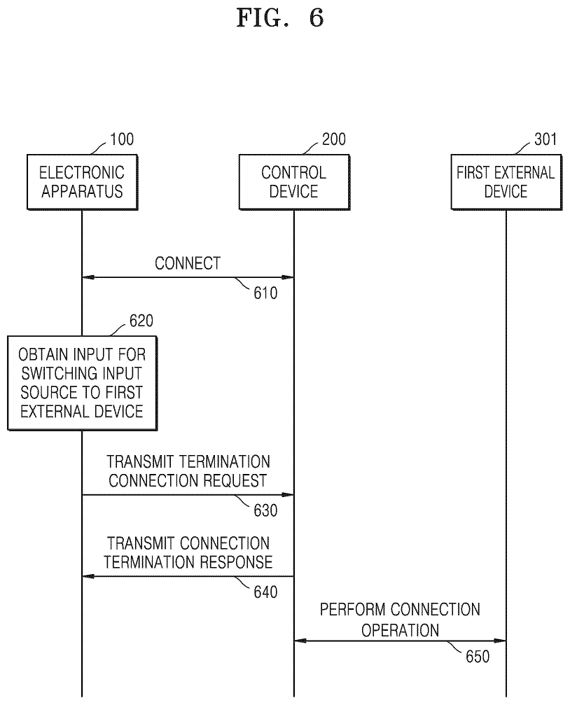

According to an embodiment of the disclosure, based on switching an input source of the electronic apparatus 100, an apparatus to which the control device 200 is connected may be switched. For example, when the input source of the electronic apparatus 100 is switched from an internal source of the electronic apparatus 100 to the first external device 301, the control device 200, which has been connected to electronic apparatus 100, may be connected to the first external device 301. Through the above, a plurality of electronic apparatuses (e.g., the electronic apparatus 100, the first external device 301, the second external device 302, and the third external device 303) may be controlled by the control device 200. In addition, the connection of the control device 200 may be smoothly switched between the electronic apparatus 100 and the external device 300 (e.g., the first external device 301, the second external device 302, and the third external device 303), thereby improving user convenience and connection accuracy. The process described above is described in greater detail below with reference to FIGS. 5 and 6, and any redundant description thereof may not be repeated here.

Hereinbelow, an example is described in which the input source of the electronic apparatus 100 is switched from the external device 300 to an internal source of the electronic apparatus 100. In the description below, for convenience of description, the first external device 301 is described as an example of the external device 300, but the disclosure is not limited thereto.

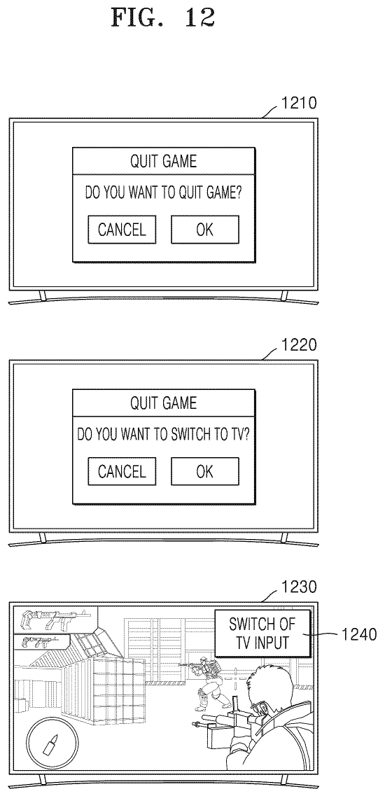

According to an embodiment of the disclosure, the electronic apparatus 100 may obtain an input for switching the input source of the electronic apparatus 100 from the first external device 301 to an internal source of the electronic apparatus 100. According to an embodiment of the disclosure, the input for switching the input source of the electronic apparatus 100 from the first external device 301 to the internal source of the electronic apparatus 100 may be obtained based on a user input received through a user interface provided by the first external device 301. According to an embodiment of the disclosure, the input for switching the input source of the electronic apparatus 100 from the first external device 301 to the internal source of the electronic apparatus 100 may be obtained, under the control by a remote controller, through a user interface provided by the electronic apparatus. According to an embodiment of the disclosure, the input for switching the input source of the electronic apparatus 100 from the first external device 301 to the internal source of the electronic apparatus 100 may be received from a server which has obtained a user input from a smart device. A method of obtaining an input for switching the input source of the electronic apparatus 100 from the first external device 301 to the internal source of the electronic apparatus 100 is described in greater detail below with reference to FIGS. 12, 13 and 14, and any redundant description may not be repeated here.

According to an embodiment of the disclosure, the electronic apparatus 100 may, in response to the input for switching an input source of the electronic apparatus 100 from the first external device 301 to an internal source of the electronic apparatus 100, transmit a command to the first external device 301 to indicate termination of the connection between the first external device 301 and the control device 200. According to an embodiment of the disclosure, the electronic apparatus 100 may perform a connection operation with the control device 200.

According to an embodiment of the disclosure, the command to terminate the connection between the first external device 301 and the control device 200 may include a connection termination reason which includes identification information of the internal source of the electronic apparatus 100. According to an embodiment of the disclosure, the connection termination reason may enable the first external device 301, which has received the command for instructing to terminate the connection, to transmit, the control device 200, a command for instructing to perform a connection operation with the electronic apparatus 100, using the identification information of the internal source of the electronic apparatus 100 included in the connection termination reason.

According to an embodiment of the disclosure, the first external device 301 may, in response to the command to terminate the connection, transmit a command to the control device 200 to perform a connection operation with the electronic apparatus 100, using the identification information of the internal source of the electronic apparatus 100 included in the connection termination reason. According to an embodiment of the disclosure, the control device 200 may perform a connection operation with the electronic apparatus 100 using the identification information of the internal source of the electronic apparatus 100 included in the connection termination reason.

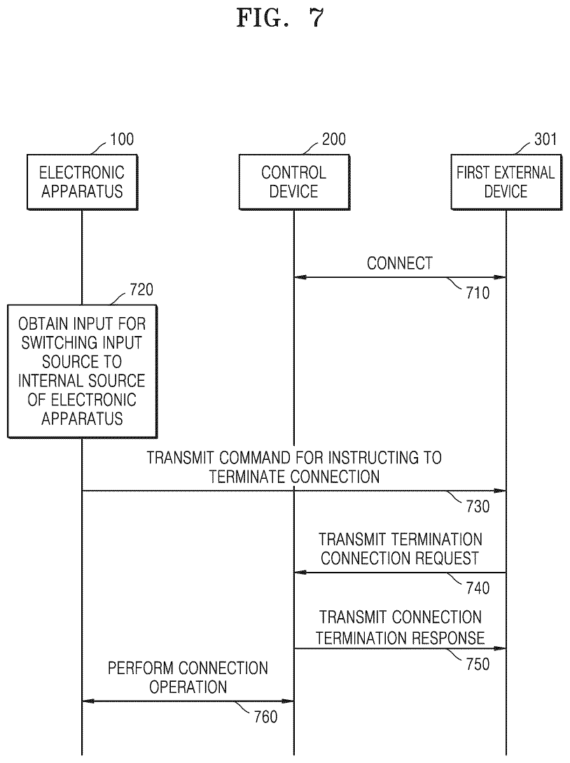

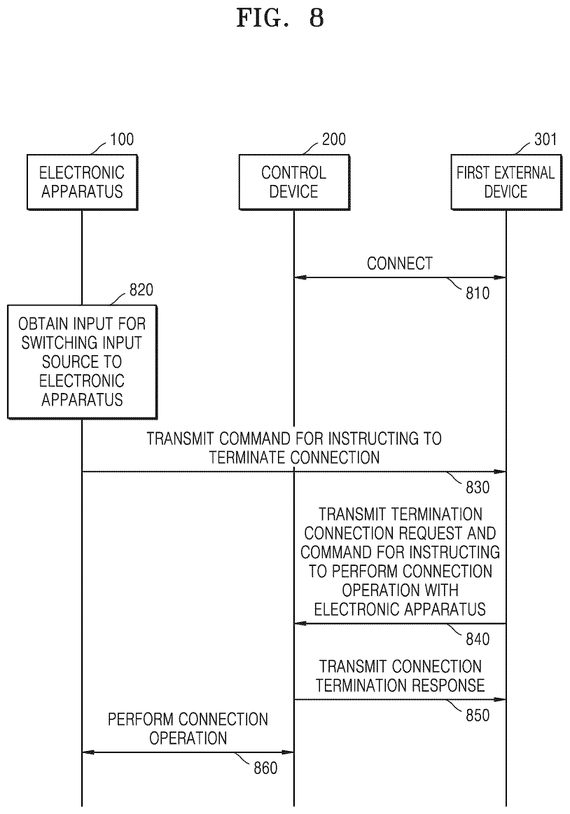

The process described above is described in greater detail below with reference to FIGS. 7 and 8, and any redundant description thereof may not be repeated here.

Hereinbelow, a case is described in which an input source of the electronic apparatus 100 is set as the external device 300. In the description below, for convenience of description, the second external device 302 is described as an example of the external device 300, but the disclosure is not limited thereto. For example, setting the input source of the electronic apparatus 100 as the second external device 302 may include switching the input source of the electronic apparatus 100 from the internal source of the electronic apparatus 100 to the second external device 302. For example, setting the input source of the electronic apparatus 100 to the second external device 302 may include switching the input source of the electronic apparatus 100 from the first external device 301 to the second external device 302. In the description below, for convenience of description, the second external device 302 is described as an example of the external device 300, but the disclosure is not limited thereto.

According to an embodiment of the disclosure, the electronic apparatus 100 may obtain an input for setting the input source of the electronic apparatus 100 as the second external device 302. According to an embodiment of the disclosure, the electronic apparatus 100 may provide a user interface for obtaining an input for setting the input source of the electronic apparatus 100. The electronic apparatus 100 may obtain, based on a user input received through the user interface, an input for setting the input source of the electronic apparatus 100 as the second external device 302.

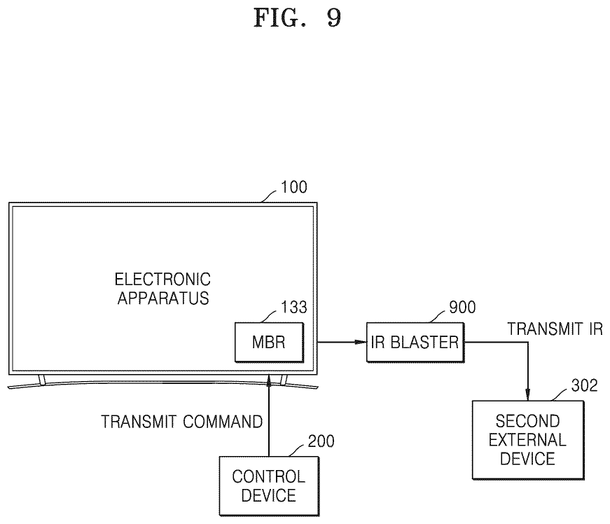

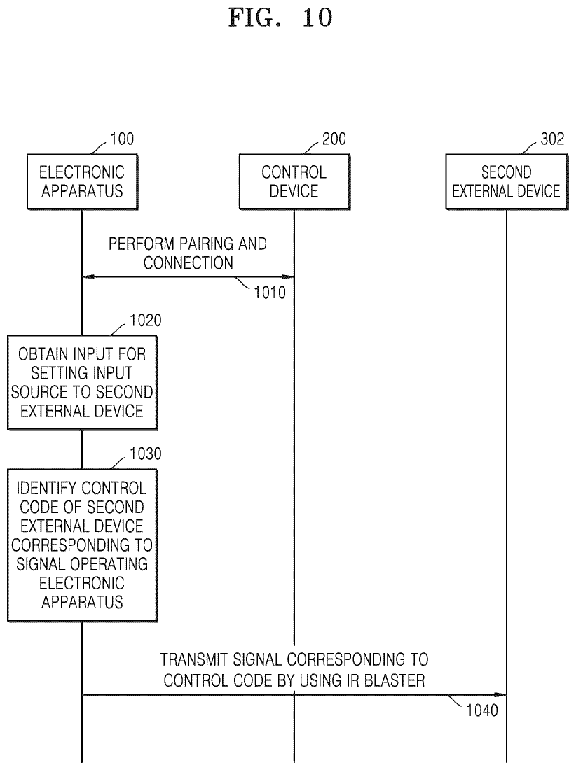

According to an embodiment of the disclosure, the electronic apparatus 100 may, in response to the input for setting the input source of the electronic apparatus 100 as the second external device 302, set the input source of the electronic apparatus 100 as the second external device 302. In addition, when the electronic apparatus 100 receives a signal of the control device 200 which operates the electronic apparatus 100, the electronic apparatus 100 may identify a control code of the second external device 302 corresponding to the signal of the control device 200. According to an embodiment of the disclosure, the electronic apparatus 100 may transmit a signal corresponding to the identified control code to the second external device 302 using an infrared (IR) blaster. The process described above is described in greater detail below with reference to FIGS. 9 and 10, and any redundant description thereof may not be repeated here.

According to an embodiment of the disclosure, the termination connection request may be transmitted through a termination connection request (TCR) packet. According to an embodiment of the disclosure, the connection termination reason may be included in a REASON field of the TCR packet.

According to an embodiment of the disclosure, the electronic apparatus 100 may be connected to the control device through a communication interface according to a Bluetooth communication protocol or a Wi-Fi communication protocol. According to an embodiment of the disclosure, the control device 200 may include a game controller.

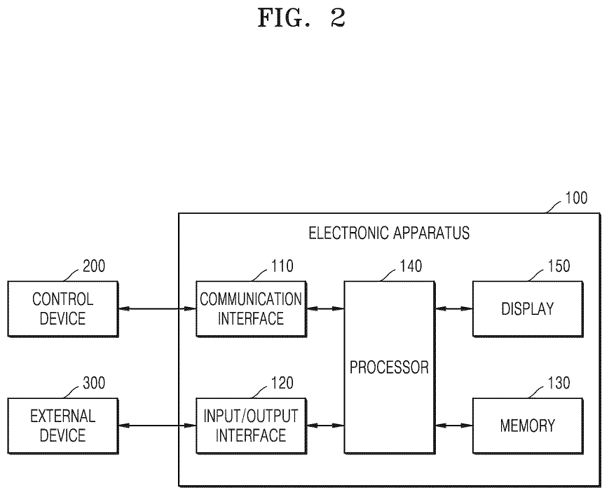

FIG. 2 is a block diagram illustrating an example configuration of a system including the electronic apparatus 100, the control device 200, and the external device 300 according to various embodiments.

According to an embodiment of the disclosure, the electronic apparatus 100 may be an apparatus capable of displaying an image or data according to a request by a user, and may include a communication interface (e.g., including circuitry)110, an input/output interface (e.g., including circuitry) 120, memory 130, a processor (e.g., including processing circuitry) 140, and a display 150.

The electronic apparatus 100 may be implemented in various forms. The electronic apparatus 100 may be any type of apparatus that includes a processor and memory and performs a function. The electronic apparatus 100 may be a stationary or portable apparatus. For example, the electronic apparatus 100 may represent an apparatus having a display and capable of displaying image content, video content, game content, graphic content, or the like. The electronic apparatus 100 may include electronic apparatuses of various forms, capable of receiving and outputting content, such as, for example, and without limitation, televisions such as network television (TV), smart TV, Internet TV, web TV, and Internet Protocol television (IPTV), computers such as desktops, laptops, and tablets, smartphones, cellular phones, game players, music players, video players, medical equipment, and home appliances, and the like. The electronic apparatus 100 may be referred to as a source device in terms of providing content, and may also be referred to as a content providing device, a display device, a computing device, or the like.

The communication interface 110 may include various communication circuitry and communicate with at least one electronic device. Here, “communication” may refer, for example, to an operation of transmitting and/or receiving data, signals, requests, and/or commands. The communication interface 110 may perform wired or wireless communication with at least one electronic device. The electronic apparatus 100 may communicate with the control device 200 through the communication interface 110. The electronic apparatus 100 may be wirelessly connected to the control device 200 through the communication interface 110.

For example, the communication interface 110 may include at least one of a communication module (e.g., including communication circuitry), a communication circuit, a communication device, an input/output port, or an input/output plug, to perform wired or wireless communication with at least one electronic device. For example, the communication interface 110 may include at least one wireless communication module, wireless communication circuit, or wireless communication device which perform wireless communication with at least one electronic device.

For example, the communication interface 110 may include a short-range communication module including various communication circuitry capable of receiving a control command from a remote controller located in close proximity, such as an IR communication module. In this case, the communication interface 110 may receive a control signal from the remote controller.

For example, the communication interface 110 may include at least one communication module which performs communication according to a wireless communication standard, such as Bluetooth, Wi-Fi, BLE, NFC/RFID, Wi-Fi Direct, UWB, or ZIGBEE. According to an embodiment of the disclosure, the communication interface 110 may further include a communication module which performs communication with a server for supporting remote communication according to a remote communication standard. For example, the communication interface 110 may include a communication module which performs communication through a network for Internet communication. In addition, the communication interface 110 may include a communication module which performs communication through a communication network following a communication standard such as 3rd-generation (3G), 4th-generation (4G), 5th-generation (5G), and/or 6th-generation (6G).

The input/output interface 120 may include various interface circuitry and transmit and receive data, signals, requests, and/or commands from the outside of the electronic apparatus 100. The input/output interface 120 may receive an input from at least one electronic device through wired or wireless communication. The electronic apparatus 100 may be connected to the external device 300 (e.g., the first external device 301, the second external device 302, or the third external device 303) through the input/output interface 120.

For example, the input/output interface 120 may include at least one port for connection to an external device to communicate with the electronic device through a wire. For example, the input/output interface 120 may include at least one of an HDMI port, a component jack, a PC port, or a USB port. Accordingly, the input/output interface 120 may communicate with the external device 300 connected through a wire through the at least one port. Here, the port may refer to a physical device configuration into which a cable, communication line, or plug may be connected or inserted.

For example, the input/output interface 120 may receive video (e.g., moving images or the like), audio (e.g., voice, music, or the like), game screens and game-related content (e.g., game play screens, game audio, user interface, streaming, updates, notifications, settings, background information, or the like), and additional information (e.g., electronic program guide (EPG) or the like) from the external device 300. The input/output interface 120 may include one or a combination of one or more of an HDMI port, a component jack, a PC port, or a USB port. The input/output interface 120 may include a DP, Thunderbolt, and Mobile High-Definition Link (MHL) in addition to the HDMI port.

As described above, the communication interface 110 and the input/output interface 120 may include at least one support element for supporting communication between the electronic apparatus 100, the control device 200, and the external device 300. The support elements may include the communication modules, communication circuits, communication devices, ports for input/output of data, cable ports for input/output of data, plugs for input/output of data, or the like described above. For example, at least one support element included in the communication interface 110 may include an Ethernet communication module, a Wi-Fi communication module, a Bluetooth communication module, an IR communication module, a USB port, a tuner (or broadcast receiver), an HDMI port, a DP, a digital visual interface (DVI) port, or the like.

The memory 130 may store a program for processing and controlling the processor 140, and may store data input to or output from the electronic apparatus 100. In addition, the memory 130 may store data necessary for an operation of the electronic apparatus 100.

The memory 130 may include at least one type of storage medium from among a flash memory type, a hard disk type, a multimedia card micro type, a card type memory (e.g., a Secure Digital (SD) or Extreme Digital (XD) memory), a Random Access Memory (RAM), a Static Random Access Memory (SRAM), Read-Only Memory (ROM), Electrically Erasable Programmable Read-Only Memory (EEPROM), Programmable Read-Only Memory (PROM), a magnetic memory, a magnetic disk, or an optical disk. The memory 130 may not exist separately and may be configured to be included in the processor 140. The memory 130 may include volatile memory, non-volatile memory, or a combination of volatile memory and non-volatile memory. The memory 130 may store a program or at least one instruction for performing operations according to embodiments of the disclosure as described below. The memory 130 may provide stored data to the processor 140 upon request by the processor 140.

The processor 140 may include various processing circuitry and control an overall operation of the electronic apparatus 100. The processor 140 is a component which controls a series of processes to cause the electronic apparatus 100 to operate according to embodiments of the disclosure as described below, and may include one or a plurality of processors. The one or plurality of processors included in the processor 140 may be circuitry, such as a system on chip (SoC), an integrated circuit (IC), or the like. The one or plurality of processors included in the processor 140 may be general-purpose processors such as a central processing unit (CPU), a microprocessor unit (MPU), an application processor (AP), a digital signal processor (DSP), or the like, dedicated graphics processors such as a graphics processing unit (GPU) and a vision processing unit (VPU), dedicated artificial intelligence (AI) processors such as a neural processing unit (NPU), and/or dedicated communication processors such as a communication processor (CP). When the one or plurality of processors included in the processor 140 are a dedicated AI processor, the AI dedicated processor may be designed with a hardware structure specialized for processing a particular AI model. Thus, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The processor 140 may write data to the memory 130 or read data stored in the memory 130, and for example, execute a program or at least one instruction stored in the memory 130 to process data according to predefined operation rules or AI models. Thus, the processor 140 may perform operations described according to embodiments of the disclosure as described below, and operations described in embodiments below as being performed by the electronic apparatus 100 or the detailed components 110, 120, 130, and 150 included in the electronic apparatus 100 may be considered as being performed by the processor 140 unless otherwise specified.

For example, the processor 140 may individually or collectively execute at least one instruction stored in the memory 130 to perform functions of the electronic apparatus 100 described in the disclosure. According to an embodiment of the disclosure, according to an embodiment of the disclosure, at least one instruction stored in the memory 130, when executed by the processor 140 individually or collectively, may cause the electronic apparatus 100 to perform the functions described in the disclosure.

The display 150 may output an image or data processed in the electronic apparatus 100.

According to an embodiment of the disclosure, the processor 140 may individually or collectively execute at least one instruction stored in the memory 130 to obtain an input for switching an input source of an electronic apparatus from an internal source of the electronic apparatus 100 to the first external device 301, to transmit, based on the input, a termination connection request (TCR) including a connection termination reason including identification information of the first external device 301 to the control device 200 connected to the electronic apparatus 100, wherein the connection termination reason enables the control device 200, which receives the termination connection request, to perform a connection operation with the first external device 301 using the identification information of the first external device 301 included in the connection termination reason, and to receive a connection termination response from the control device 200 in response to the termination connection request.

According to an embodiment of the disclosure, the processor 140 may individually or collectively execute at least one instruction stored in the memory 130 to obtain an input for switching an input source of the electronic apparatus 100 from the first external device 301 to an internal source of the electronic apparatus 100, and to transmit, in response to the input, a command to the first external device 301 for instructing to terminate the connection between the first external device 301 and the control device 200, and perform a connection operation with the control device 200.

According to an embodiment of the disclosure, the command for instructing to terminate the connection between the first external device 301 and the control device 200 includes a connection termination reason including identification information of an internal source of the electronic apparatus 100, and the connection termination reason enables the first external device 301, which has received the command for instructing to terminate the connection, to transmit, to the control device 200, a command for instructing to perform the connection operation with the electronic apparatus 100 using the identification information of the internal source of the electronic apparatus 100 included in the connection termination reason.

According to an embodiment of the disclosure, the input for switching the input source of the electronic apparatus 100 may be obtained based on a user input received through a user interface provided by the first external device 301.

According to an embodiment of the disclosure, the input for switching the input source of the electronic apparatus 100 may be obtained, under the control by a remote controller, through the user interface provided by the electronic apparatus 100.

According to an embodiment of the disclosure, the input for switching the input source of the electronic apparatus 100 may be received from a server which has obtained a user input from a smart device.

According to an embodiment of the disclosure, the processor 140 may be configured to individually or collectively execute at least one instruction stored in the memory 130 to obtain an input for setting the input source of the electronic apparatus 100 as the second external device 302, to identify, in response to the input, a control code of the second external device 302 corresponding to a signal of the control device 200 for operating the electronic apparatus 100, and to transmit a signal corresponding to the identified control code to the second external device 302 using an IR blaster.

According to an embodiment of the disclosure, the TCR may be transmitted through a TCR packet, and the connection termination reason may be included in a REASON field of the TCR packet.

According to an embodiment of the disclosure, the processor 140 may be configured to individually or collectively execute at least one instruction stored in memory 130 to connect the electronic apparatus 100 to the control device 200 through the communication interface 110 according to a Bluetooth communication protocol or a Wi-Fi communication protocol.

The block diagram of the electronic apparatus 100 shown in FIG. 2 is a block diagram illustrating an example embodiment. Each element of the block diagram may be integrated, added, or omitted depending on the specifications of the electronic apparatus 100 to be actually implemented. For example, two or more elements may be combined into one element, or one element may be subdivided into two or more elements, as necessary. In addition, functions performed in each block are for describing embodiments, and specific operations or devices thereof do not limit the scope of the disclosure.

In FIG. 2, the electronic apparatus 100 includes a display. However, the disclosure is not limited thereto. For example, the electronic apparatus 100 may be an apparatus that provides content to an external display device including a display. The content may include, but is not limited to, images, video, audio, text, games, applications, or the like. The electronic apparatus 100 may be configured to be connected to the external device 300 through an input/output interface, such as an HDMI port, and to transmit a video/audio signal to the external device 300. The electronic apparatus 100 may be connected to the control device 200 through wired communication, short-range wireless communication such as wireless local area network (LAN) (W-LAN), Wi-Fi, or Bluetooth, or long-range wireless communication.

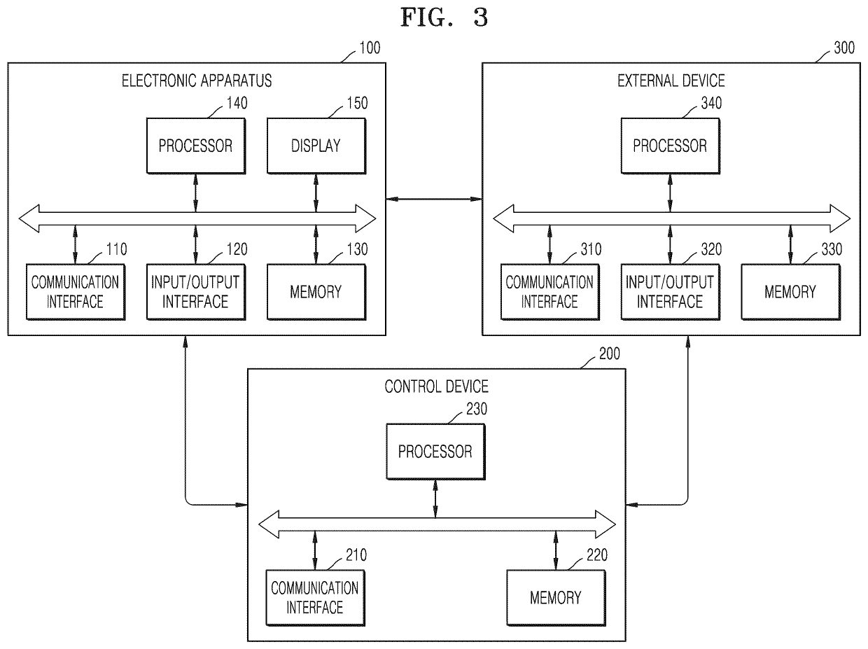

The control device 200 and the external device 300 are described in greater detail below with reference to FIG. 3.

FIG. 3 is a block diagram illustrating an example configuration of a system including the electronic apparatus 100, the control device 200, and the external device 300 according to various embodiments.

The control device 200 may be implemented in various forms. The control device 200 may be any type of device that performs a function, such as a processor and memory. The control device 200 may be a stationary or portable device. For example, the control device 200 may represent a device capable of manipulating an electronic apparatus in various ways and providing an input. For example, the control device 200 may include various forms of electronic apparatus capable of controlling functions of and providing input to the electronic apparatus 100, such as various smart devices, such as, for example, and without limitation, a remote controller, a game pad, a mouse, a keyboard joystick, a touchpad, a smartphone, a cellular phone, a computer such as a tablet, or the like. The control device 200 may be referred to as a control device in that the control device 200 controls content of the electronic apparatus, and may also be referred to as an input device, an operating device, a sink device, a user device, a controller, a remote control device, a computing device, or the like.

The control device 200 may include a communication interface (e.g., including circuitry) 210, memory 220, and a processor (e.g., including processing circuitry) 230. However, the control device 200 may be implemented by more elements than the shown elements and is not limited to the examples described above.

The communication interface 210 may include one or more modules including various circuitry which enable wireless communication between the control device 200 and a wireless communication system or between the control device 200 and a network in which other devices are located. According to an embodiment of the disclosure, the communication interface 210 may perform communication with the electronic apparatus 100 or the external device 300 according to a short-range communication technology. The short-range communication technology may include, for example, Bluetooth communication, Wi-Fi communication, infrared communication, or the like.

The memory 220 may store a program for processing and controlling the processor 230, and may store data input to or output from the control device 200.

The memory 220 may include at least one type of storage medium from among a flash memory type, a hard disk type, a multimedia card micro type, a card type memory (e.g., an SD or XD memory), a RAM, an SRAM, ROM, EEPROM, PROM, a magnetic memory, a magnetic disk, or an optical disk. The memory 220 may not exist separately and may be configured to be included in the processor 230. The memory 220 may include volatile memory, non-volatile memory, or a combination of volatile memory and non-volatile memory. The memory 220 may store a program or at least one instruction for performing operations according to embodiments of the disclosure as described below. The memory 220 may provide stored data to the processor 230 upon request by the processor 230.

The processor 230 may include various processing circuitry and control an overall operation of the control device 200. For example, the processor 230 may execute at least one instruction stored in the memory 220 to perform functions of the control device 200 described in the disclosure.

In an embodiment of the disclosure, the processor 230 may store at least one instruction in an internally provided memory, and execute the at least one instruction stored in the internally provided memory to control the above-described operations to be performed. For example, the processor 230 may execute at least one instruction or program stored in the internal memory provided inside the processor 230 or in the memory 220 to perform a certain operation.

The processor 230 is a component which controls a series of processes to cause the control device 200 to operate according to embodiments of the disclosure as described below, and may include one or a plurality of processors. The one or plurality of processors included in the processor 230 may be circuitry, such as a SoC, an IC, or the like. The one or plurality of processors included in the processor 230 may be general-purpose processors such as a CPU, an MPU, an AP, a DSP, or the like, dedicated graphics processors such as a GPU and a VPU, dedicated AI processors such as an NPU, or dedicated communication processors such as a CP. When the one or plurality of processors included in the processor 230 are a dedicated AI processor, the AI dedicated processor may be designed with a hardware structure specialized for processing a particular AI model. Thus, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The processor 230 may write data to or read data stored in the memory 220, and in particular, execute a program or at least one instruction stored in the memory 220 to process data according to predefined operation rules or AI models. Thus, the processor 230 may perform operations described according to embodiments of the disclosure as described below, and operations described in embodiments below as being performed by the detailed components 210, 230, and 240 included in the control device 200 or the control device 200 may be considered as being performed by the processor 230 unless otherwise specified.

According to an embodiment of the disclosure, the processor 230 may execute at least one instruction stored in the memory 220 to perform a communication connection using a short-range wireless communication technology with the electronic apparatus 100 and/or the external device 300. The short-range wireless communication technology may include Bluetooth communication technology or Wi-Fi Direct technology.

According to an embodiment of the disclosure, the processor 230 may execute at least one instruction stored in the memory 220 to control the communication interface 210 to establish a communication connection with the electronic apparatus 100 and/or the external device 300 according to the Bluetooth communication protocol.

According to an embodiment of the disclosure, the processor 230 may execute at least one instruction stored in the memory 220 to receive, from the electronic apparatus 100, a TCR including a connection termination reason including identification information of the first external device 301.

According to an embodiment of the disclosure, the processor 230 may execute at least one instruction stored in the memory 220 to perform a connection operation with the first external device 301 using the identification information of the first external device 301 included in the connection termination reason.

According to an embodiment of the disclosure, the processor 230 may execute at least one instruction stored in the memory 220 to transmit a connection termination response to the electronic apparatus 100.

According to an embodiment of the disclosure, the processor 230 may execute at least one instruction stored in the memory 220 to perform a connection operation with the electronic apparatus 100.

According to an embodiment of the disclosure, the processor 230 may execute at least one instruction stored in the memory 220 to receive, from the first external device 301, a command for instructing to perform the connection operation with the electronic apparatus 100. The command for instructing to perform the connection operation with the electronic apparatus 100, received from the first external device 301, may be a command for instructing to perform the connection operation with the electronic apparatus 100 using the identification information of the internal source of the electronic apparatus 100.

The control device 200 may be any type of device that performs a function, such as a processor and memory. The control device 200 may include various electronic apparatuses capable of performing Bluetooth communication. The control device 200 may be referred to as a control device in the sense that the control device 200 controls the electronic apparatus 100 by transmitting data to the electronic apparatus 100, and may also be referred to as various other electronic apparatuses, such as a computing device, a content reception device, a Bluetooth communication device, or a sink device.

The block diagram of the control device 200 illustrated in FIG. 3 is a block diagram for an example of the disclosure. Each element of the block diagram may be integrated, added, or omitted depending on the specifications of the control device 200 to be actually implemented. For example, two or more elements may be combined into one element, or one element may be subdivided into two or more elements, as necessary. In addition, functions performed in each block are for describing embodiments, and specific operations or devices thereof do not limit the scope of the disclosure.

The external device 300 is described in greater detail below.

The external device 300 may be implemented in various forms. The external device 300 may be any type of device that performs a function, such as a processor and memory. The external device 300 may be a stationary or portable device. For example, the external device 300 may represent a device which provides various types of input to the electronic apparatus 100. For example, the external device 300 may represent a device which may provide image content, video content, game content, graphic content, sound content, or the like to the electronic apparatus 100.

For example, the external device 300 may include various forms of electronic apparatus which may provide an input to the electronic apparatus 100, such as various smart devices such as, for example, and without limitation, a game console, a set-top box, a sound bar, a Blu-ray player, a Digital Versatile Disc (DVD) player, a media streaming device, a home automation hub, a projector, or the like. The external device 300 may be referred to as an external device in the sense that the external device 300 is a device external to the electronic apparatus which provides content to the electronic apparatus, and may also be referred to as a source device, an external input device, an external source device, a cloud source device, a computing device, or the like.

The external device 300 may include a communication interface (e.g., including circuitry) 310, an input/output interface (e.g., including circuitry) 320, memory 330, and a processor (e.g., including processing circuitry) 340. However, the external device 300 may be implemented by more elements than the shown elements and is not limited to the examples described above. For example, the external device 300 may have a separate audio processing interface for processing audio of an application executed on the external device 300 and/or a separate audio output interface for outputting audio.

The communication interface 310 may include one or more modules including various communication circuitry which enable wireless communication between the external device 300 and a wireless communication system or between the external device 300 and a network in which other devices are located. According to an embodiment of the disclosure, the communication interface 310 may perform communication with the control device 200 according to the Bluetooth communication protocol or the Wi-Fi communication protocol. The external device 300 may be connected to the control device 200 through a communication interface.

The input/output interface 320 may include various circuitry and transmit data, a signal, a request, and/or a command processed in the external device 300 to the electronic apparatus 100. The input/output interface 320 may receive an input from at least one electronic device through wired or wireless communication. The external device 300 may be connected to the electronic apparatus 100 through the input/output interface 320.

For example, the input/output interface 320 may include at least one port for connection to an external device to communicate with the electronic device through a wire. For example, the input/output interface 320 may include at least one of an HDMI port, a component jack, a PC port, or a USB port. Accordingly, the input/output interface 320 may communicate with the electronic apparatus 100 connected through a wire through the at least one port. The port may refer to a physical device configuration into which a cable, communication line, or plug may be connected or inserted.

For example, the input/output interface 320 may transmit video (e.g., moving images or the like), audio (e.g., voice, music, or the like), game screens and game-related content (e.g., game play screens, game audio, user interface, streaming, updates, notifications, settings, background information, or the like), and additional information (e.g., electronic program guide (EPG) or the like) to the electronic apparatus 100. The input/output interface 320 may include one or a combination of one or more of an HDMI port, a component jack, a PC port, or a USB port. The input/output interface 320 may include a DP, Thunderbolt, and MHL in addition to the HDMI port.

The memory 330 may store a program for processing and controlling the processor 340, and may store data input to or output from the external device 300.

The memory 330 may include at least one type of storage medium from among a flash memory type, a hard disk type, a multimedia card micro type, a card type memory (e.g., an SD or XD memory), a RAM, an SRAM, ROM, EEPROM, PROM, a magnetic memory, a magnetic disk, or an optical disk. The memory 330 may not exist separately and may be configured to be included in the processor 340. The memory 330 may include volatile memory, non-volatile memory, or a combination of volatile memory and non-volatile memory. The memory 330 may store a program or at least one instruction for performing operations according to embodiments of the disclosure as described below. The memory 330 may provide stored data to the processor 340 upon request by the processor 340.

The processor 340 may include various processing circuitry and control an overall operation of the external device 300. The processor 340 is a component which controls a series of processes to cause the external device 300 to operate according to embodiments of the disclosure as described below, and may include one or a plurality of processors. The one or plurality of processors included in the processor 340 may be circuitry, such as a SoC, an IC, or the like. The one or plurality of processors included in the processor 340 may be general-purpose processors such as a CPU, an MPU, an AP, a DSP, or the like, dedicated graphics processors such as a GPU and a VPU, dedicated AI processors such as an NPU, or dedicated communication processors such as a CP. When the one or plurality of processors included in the processor 340 are a dedicated AI processor, the AI dedicated processor may be designed with a hardware structure specialized for processing a particular AI model. Thus, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The processor 340 may write data to the memory 330 or read data stored in the memory 330, and in particular, execute a program or at least one instruction stored in the memory 330 to process data according to predefined operation rules or AI models. Thus, the processor 340 may perform operations described according to embodiments of the disclosure as described below, and operations described in embodiments below as being performed by the external device 300 or the detailed components 310, 320, and 330 included in the external device 300 may be considered as being performed by the processor 340 unless otherwise specified.

For example, the processor 340 may execute at least one instruction stored in the memory 330 to perform functions of the external device 300 described in the disclosure.

In an embodiment of the disclosure, the processor 340 may store at least one instruction in an internally provided memory, and execute the at least one instruction stored in the internally provided memory to control the above-described operations to be performed. For example, the processor 340 may execute at least one instruction or program stored in the internal memory provided inside the processor 340 or in the memory 330 to perform a certain operation. According to an embodiment of the disclosure, at least one instruction stored in the memory 330, when executed by the processor 340 individually or collectively, may cause the external device to perform the functions described in the disclosure.

According to an embodiment of the disclosure, the processor 340 may execute at least one instruction stored in the memory 330 to perform a connection operation with the control device 200.

According to an embodiment of the disclosure, the processor 340 may execute at least one instruction stored in the memory 330 to transmit, to the electronic apparatus 100, an input for switching an input source of the electronic apparatus from the external device 300 to an internal source of the electronic apparatus 100.

According to an embodiment of the disclosure, the processor 340 may execute at least one instruction stored in the memory 330 to receive, from the electronic apparatus 100, a command for instructing to terminate the connection between the external device 300 and the control device 200. According to an embodiment of the disclosure, the processor 340 may execute at least one instruction stored in memory 330 to transmit, to the electronic apparatus 100, a response for terminating the connection with the control device 200 in response to the command for instructing to terminate the connection between the external device 300 and the control device 200.

According to an embodiment of the disclosure, the processor 340 may execute at least one instruction stored in the memory 330, when receiving a command for instructing to terminate a connection between the external device 300 and the control device 200, to transmit, to the control device 200, a command for instructing to perform a connection operation with the electronic apparatus 10 using identification information of an internal source of the electronic apparatus 100 included in a connection termination reason.

According to an embodiment of the disclosure, the processor 340 may execute at least one instruction stored in the memory 330 to provide a user interface capable of receiving an input for switching an input source of the electronic apparatus 100. According to an embodiment of the disclosure, the processor 340 may execute at least one instruction stored in the memory 330 to obtain an input for switching an input source of the electronic apparatus 100 based on a user input received through the user interface. According to an embodiment of the disclosure, the processor 340 may execute at least one instruction stored in the memory 330 to transmit, to the electronic apparatus 100, the input for switching the input source of the electronic apparatus 100.

According to an embodiment of the disclosure, the processor 340 may execute at least one instruction stored in the memory 330 to control the communication interface 310 to transmit a connection response in response to a connection request from the control device 200.

The block diagram of the external device 300 shown in FIG. 3 is a block diagram for an example embodiment of the disclosure. Each element of the block diagram may be integrated, added, or omitted depending on the specifications of the external device 300 to be actually implemented. For example, two or more elements may be combined into one element, or one element may be subdivided into two or more elements, as necessary. In addition, functions performed in each block are for describing embodiments, and specific operations or devices thereof do not limit the scope of the disclosure.

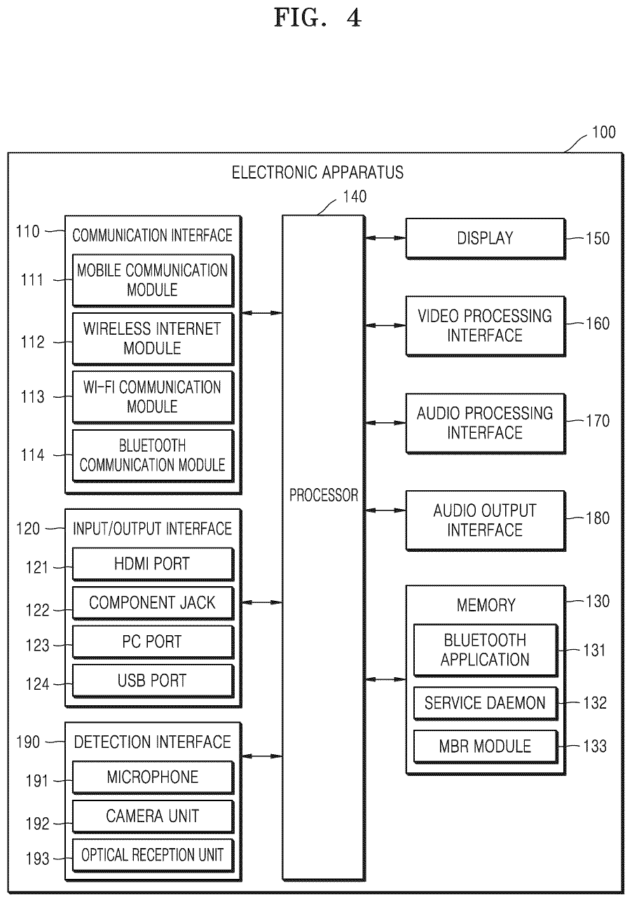

FIG. 4 is a block diagram illustrating an example configuration of an electronic apparatus according to various embodiments.

Referring to FIG. 4, the electronic apparatus 100 may include a video processing interface (e.g., including circuitry) 160, an audio processing interface (e.g., including circuitry) 170, an audio output interface (e.g., including circuitry) 180, and a detection interface (e.g., including circuitry) 190 in addition to the communication interface 110, the input/output interface 120, the memory 130, the processor 140, the display 150 described above.

The communication interface 110 may include one or more modules include various communication circuitry which enable wireless communication between the electronic apparatus 100 and a wireless communication system or between the electronic apparatus 100 and a network in which other electronic apparatuses are located. For example, the communication interface 110 may include a mobile communication module 111, a wireless Internet module 112, a Wi-Fi communication module 113, and a Bluetooth communication module 114.

The mobile communication module 111 may transmit and receive a wireless signal with at least one of a base station, an external terminal, or a server on a mobile communication network. The wireless signal may include various forms of data according to voice call signals, video call signals, or text/multimedia message transmission and reception.

The wireless Internet module 112 may refer to a module for wireless Internet connection and may be built into or external to the device. Wireless Internet technologies may include Wireless LAN (WLAN) (Wi-Fi), Wireless broadband (Wibro), World Interoperability for Microwave Access (Wimax), High Speed Downlink Packet Access (HSDPA), or the like. Through the wireless Internet module 112, the electronic apparatus may establish a Wi-Fi Peer to Peer (P2P) connection with other electronic apparatuses.

The communication interface 110 may include a short-range communication module for short-range communication. Short-range communication technologies may include Bluetooth, BLE, Radio Frequency Identification (RFID), infrared Data Association (IrDA), UWB, ZIGBEE, or the like. The communication interface 110 may include the Wi-Fi communication module 113 and the Bluetooth communication module 114 as a short-range communication module.

The Wi-Fi communication module 113 may establish a communication connection and perform communication according to the Wi-Fi communication protocol with the control device 200 under the control by the processor 140. The Bluetooth communication module 114 may establish a communication connection and perform communication according to the Bluetooth communication protocol with the control device 200 under the control by the processor 140.

The input/output interface 120 may include various circuitry and receive, from the outside of the electronic apparatus 100 under the control by the processor 140, video (e.g., moving images or the like), audio (e.g., voice, music, or the like), game screens and game-related content (e.g., game play screens, game audio, user interface, streaming, updates, notifications, settings, background information, or the like), and additional information (e.g., electronic program guide (EPG) or the like). The input/output interface 120 may include one or a combination of one or more of an HDMI port 121, a component jack 122, a PC port 123, or a USB port 124. The input/output interface 120 may include a DP, Thunderbolt, and Mobile High-Definition Link (MHL) in addition to the HDMI port 121.

The input/output interface 120 may be connected to the external device 300 under the control by the processor 140 and may receive, from the external device 300, video (e.g., moving images or the like), audio (e.g., voice, music, or the like), game screens and game-related content (e.g., game play screens, game audio, user interface, streaming, updates, notifications, settings, background information, or the like), and additional information (e.g., electronic program guide (EPG) or the like).

The memory 130 may store programs related to an operation of the electronic apparatus 100 and various data generated during the operation of the electronic apparatus 100. The memory 130 may store at least one instruction. In addition, the memory 130 may store at least one instruction to be executed by the processor 140. In addition, the memory 130 may store at least one program to be executed by the processor 140. In addition, the memory 130 may store an application for providing a certain service.

For example, the memory 130 may include at least one type of storage medium from among a flash memory type, a hard disk type, a multimedia card micro type, a card type memory (e.g., an SD or XD memory), a RAM, an SRAM, ROM, EEPROM, PROM, a magnetic memory, a magnetic disk, or an optical disk.

According to an embodiment of the disclosure, the memory 130 may store a Bluetooth application 131, a Wi-Fi service daemon 132 and a membrane bioreactor (MBR) module 133.

The processor 140 may include various processing circuitry and control the overall operation of the electronic apparatus 100. For example, the processor 140 may individually or collectively execute at least one instruction stored in the memory 130 to perform the functions of the electronic apparatus 100 described in the disclosure.

In an embodiment of the disclosure, the processor 140 may store at least one instruction in an internally provided memory, and execute the at least one instruction stored in the internally provided memory to control the operations of the display device to be performed. For example, the processor 140 may execute at least one instruction or program stored in the internal memory provided inside the processor 140 or in the memory 130 to perform a certain operation. A more detailed description of the processor 140 is provided above and may not be repeated here.

According to an embodiment of the disclosure, the processor 140 may execute at least one instruction stored in the memory 130 to perform a function of the electronic apparatus 100 described in the disclosure.

The display 150 may display an image signal on the screen.

The video processing interface 160 may include various circuitry and process an image signal received from the communication interface 110 or the input/output interface 120 and output the processed image signal to the display 150, under the control by the processor 140.

The audio processing interface 170 may include various circuitry and convert an audio signal received from the communication interface 110 or the input/output interface 120 into an analog audio signal and output the analog audio signal to the audio output interface 180, under the control by the processor 140.

The audio output interface 180 may include various circuitry and output audio (e.g., voice or sound) input from the communication interface 110 or the input/output interface 120. In addition, the audio output interface 180 may output audio stored in the memory 130 under the control by the processor 140. The audio output interface 180 may include at least one or a combination of a speaker, a headphone output terminal, or a Sony/Philips Digital Interface (S/PDIF) output terminal.

The detection interface 190 may include various circuitry and detects a user's voice, a user's image, or a user's interaction, and may include a microphone 191, a camera unit 192, and an optical reception unit 193.

The microphone 191 may receive a user's uttered voice. The microphone 191 may convert the received voice into an electrical signal, and output the electrical signal to the processor 140. The user voice may include, for example, a voice corresponding to a menu or function of the electronic apparatus 100.

The camera unit 192 may include at least one camera and receive an image (e.g., consecutive frames) corresponding to a user's motion including a gesture within a camera recognition range. The processor 140 may select a menu displayed on the electronic apparatus 100 or perform a control corresponding to the motion recognition result using the recognition result of the received motion.

The optical reception unit 193 may include various circuitry and receive an optical signal (including a control signal) from an external control device. The optical reception unit 193 may receive an optical signal corresponding to a user input (e.g., a touch, a press, a touch gesture, a voice, or a motion) from the control device. A control signal may be extracted from the received optical signal under the control by the processor 140.

FIG. 5 is a flowchart illustrating an example method of operating an electronic apparatus, according to various embodiments. Because the operations included in the flowchart of FIG. 5 may be performed by the electronic apparatus 100 of FIGS. 1, 2, 3 and 4 (which may be referred to as FIGS. 1 to 4), the details described above with reference to FIGS. 1 to 4 may be equally applied to FIG. 5, even when not repeated below.

Referring to FIG. 5, in operation 510, the electronic apparatus 100 may wirelessly connect to the control device 200 through the communication interface 110. The electronic apparatus 100 may be wirelessly connected to the control device 200 in various manners. For example, the electronic apparatus 100 may be wirelessly connected to the control device 200 according to the Bluetooth communication protocol. For example, the electronic apparatus 100 may be wirelessly connected to the control device 200 according to the Wi-Fi communication protocol. In addition, the electronic apparatus 100 may be wirelessly connected to the control device 200 through IrDA, NFC, ZIGBEE, but an embodiment of the disclosure is not limited thereto.

In operation 520, the electronic apparatus 100 may obtain an input for switching an input source of the electronic apparatus from an internal source of the electronic apparatus 100 to the external device 300.

For example, the electronic apparatus 100 may obtain an input for switching an input source of the electronic apparatus 100 from an internal source of the electronic apparatus 100 to the first external device 301.

The internal source of the electronic apparatus 100 may refer to content and function built into the electronic apparatus 100. For example, the internal source of the electronic apparatus 100 may refer to content and function directly accessible from the electronic apparatus 100. For example, the internal source of the electronic apparatus 100 may include video, audio, photos, applications, streaming services, built-in games, game streaming services, digital media players, content libraries, TV tuners and broadcast reception functions, content stored on built-in storage, and default software stored on the electronic apparatus 100.

According to an embodiment of the disclosure, when the input source of the electronic apparatus 100 is set as an internal source of the electronic apparatus 100, the electronic apparatus 100 may execute various applications through a built-in operating system (OS). The applications may include streaming services, games, media players, or the like. In addition, the electronic apparatus 100 may store and play multimedia content, such as movies, music, or photos, through the built-in storage.

According to an embodiment of the disclosure, when the input source of the electronic apparatus 100 is set as an internal source of the electronic apparatus 100, the electronic apparatus 100 may directly receive and display terrestrial, cable, and satellite broadcasting without an external set-top box through a broadcast reception function, such as a TV tuner. According to an embodiment of the disclosure, when the input source of the electronic apparatus 100 is set as an internal source of the electronic apparatus 100, the electronic apparatus 100 may provide enjoyable game experience without an external game console through a built-in game function or a cloud-based game streaming service.

Below are non-limiting examples of a method of obtaining an input for switching an input source, but an embodiment of the disclosure is not limited to the listed examples.

According to an embodiment of the disclosure, the electronic apparatus 100 may receive an input for switching an input source, through a user interface (UI). In an embodiment of the disclosure, the electronic apparatus 100 may provide a user interface capable of setting an input source. According to an embodiment of the disclosure, the electronic apparatus 100 may obtain an input for setting or switching an input source of the electronic apparatus 100, based on a user input received through the UI of the electronic apparatus 100.

For example, the setting or switching of the input source of the electronic apparatus 100 may occur through a button click on the control device 200, a touchscreen operation on the electronic apparatus 100, a voice command, or the like. The electronic apparatus 100 may obtain an input for setting the input source of the electronic apparatus 100 to the first external device 301, and switch the input source to the first external device 301 by adjusting an internal configuration. For example, when a user enters an “Input Source (or External Input)” menu in a menu displayed on the display 150 of the electronic apparatus 100 and selects the first external device 301 (e.g. High-Definition Multimedia Interface (HDMI) 2, component input, game console, set-top box, sound bar, or other name of an external device set by the user) using a remote controller, the electronic apparatus 100 may obtain the user input.

For example, the electronic apparatus 100 may recognize the connection of the external device 300. When the electronic apparatus 100 detects the connection of the external device 300 (for example, when the external device 300 is connected to the input/output interface 120 of the electronic apparatus 100), a UI capable of receiving an input for switching the input source of the electronic apparatus 100 may be received. According to an embodiment of the disclosure, the electronic apparatus 100 may determine whether to set or switch the input source of the electronic apparatus 100, based on the user input received through the UI of the electronic apparatus 100.

According to an embodiment of the disclosure, the electronic apparatus 100 may receive the input for switching an input source, through the detection interface 190. For example, the electronic apparatus 100 may obtain the input for switching the input source of the electronic apparatus 100, based on a user's voice command obtained through the microphone 191. For example, when the user says “Switch to HDMI 1”, the electronic apparatus 100 may recognize the voice command and switch the input source from an internal source of the electronic apparatus 100 to the first external device 301 (e.g., a device connected to the HDMI 1 input).

According to an embodiment of the disclosure, the electronic apparatus 100 may obtain an input for switching an input source, based on a set rule. The rule may be replaced with a schedule, signal, turn-on/off of power. For example, the electronic apparatus 100 may obtain an input for automatically switching the input source from the electronic apparatus 100 to the first external device 301, when the electronic apparatus 100 detects that the first external device 301 is powered on or transmitting a specific signal. For example, the electronic apparatus 100 may obtain an input for automatically switching the input source, according to a preset schedule. For example, when the first external device 301 is scheduled to start content (e.g. broadcast, game, radio, or audio) at a certain time, then when the time comes, the electronic apparatus 100 may obtain an input for switching the input source of the electronic apparatus 100 from the electronic apparatus 100 to the first external device 301.

According to an embodiment of the disclosure, the electronic apparatus 100 may obtain an input for switching the input source, through a server. For example, when the user transmits, to the server, a command for changing the input source of the electronic apparatus 100 to the first external device 301 through a smartphone application, the electronic apparatus 100 may receive the command and obtain an input for switching the input source.

According to an embodiment of the disclosure, the electronic apparatus 100 may switch the input source of the electronic apparatus 100 based on the input for switching the input source of the electronic apparatus 100, obtained according to the example above. For example, the input source of the electronic apparatus 100 may be switched from an internal source of the electronic apparatus 100 to the first external device 301 based on the input for switching the input source of the electronic apparatus from the internal source of the electronic apparatus 100 to the first external device 301.

In operation 530, the electronic apparatus may transmit a TCR to a control device connected to the electronic apparatus.

According to an embodiment of the disclosure, the electronic apparatus 100 may transmit, to the control device 200 connected to the electronic apparatus 100, a TCR including a connection termination reason including identification information of the first external device 301, based on the input for switching the input source of the electronic apparatus from the internal source of the electronic apparatus 100 to the first external device 301.

According to an embodiment of the disclosure, the electronic apparatus 100 may be paired and/or connected with the control device 200. The electronic apparatus 100 may be connected to the control device 200 through the Bluetooth communication protocol or the Wi-Fi communication protocol.

The electronic apparatus 100 may transmit the TCR to the control device 200 through the communication interface 110. According to an embodiment of the disclosure, the electronic apparatus 100 may transmit the TCR to the control device 200 through the Bluetooth communication protocol or the Wi-Fi communication protocol. For example, the electronic apparatus 100 may transmit the TCR to the control device 200 through a TCR packet. For example, the electronic apparatus 100 may transmit the TCR to the control device 200 through the Bluetooth application 131 or the service daemon 132.

For example, the TCR may be included in a disconnection command or a link termination command according to the Bluetooth communication protocol. For example, the TCR may be included in a disconnection command according to the Wi-Fi communication protocol.

According to an embodiment of the disclosure, the TCR may refer to a message sent to terminate or release a connection between the electronic apparatus 100 and the control device 200. In an embodiment of the disclosure, the TCR may include a connection termination reason.

For example, the connection termination reason may refer to a code or message indicating a reason for terminating the connection between the electronic apparatus 100 and the control device 200. For example, in the Bluetooth communication protocol, 0x00 may refer to normal termination (Connection Terminated by Local Host), 0x13 may refer to user termination (User Request), 0x1A may refer to hardware failure, and 0x1F may refer to resource constraints.

According to an embodiment of the disclosure, the connection termination reason may include identification information of the external device 300 (e.g., the first external device 301, the second external device 302, or the third external device 303). Here, the external device 300 may refer to a device which the electronic apparatus 100 sets (or switches) as the input source of the electronic apparatus 100 in operation 510.

For example, when the electronic apparatus 100 obtains an input for switching the input source of the electronic apparatus 100 from the internal source of the electronic apparatus 100 to CONSOLE or HDMI 1, the electronic apparatus 100 may transmit a TCR including a connection termination reason, such as “REASON: CONSOLE CONNECTED” or “REASON: HDMI 1 CONNECTED”, to the control device 200 connected to the electronic apparatus 100.

In an embodiment of the disclosure, the connection termination reason “REASON: CONSOLE CONNECTED” may indicate that the reason the electronic apparatus 100 terminates the connection between the electronic apparatus 100 and the control device 200 is because the input source of the electronic apparatus 100 is switched to an external device of which the identification information is CONSOLE. In an embodiment of the disclosure, the connection termination reason “CONSOLE” of “REASON: CONSOLE CONNECTED” may indicate identification information of an external device for which a switch request has been made. For example, the identification information “CONSOLE” may be information for identifying a game console.

According to an embodiment of the disclosure, the connection termination reason may include identification information of the input/output interface 120 of the electronic apparatus 100 to which the external device 300 (e.g., the first external device 301, the second external device 302, or the third external device 303) to which the switching request has been made is connected. Here, the external device 300 may refer to a device which the electronic apparatus 100 sets (or switches) as the input source of the electronic apparatus 100 in operation 510.

In an embodiment of the disclosure, the connection termination reason “REASON: HDMI 1 CONNECTED” may indicate that the reason why the electronic apparatus 100 terminates the connection between the electronic apparatus 100 and the control device 200 is because the input source of the electronic apparatus 100 was switched to an external device connected through an input/output interface having the identification information “HDMI 1”. In an embodiment of the disclosure, the connection termination reason “HDMI 1” of “REASON: HDMI 1 CONNECTED” may indicate identification information of the input/output interface 120 of the electronic apparatus 100 to which the external device 300 to which the switching request has been made is connected. For example, “HDMI 1” may represent a first HDMI port of the input/output interface 120. For example, the connection termination reason “REASON: HDMI 1 CONNECTED” may indicate that the reason why the electronic apparatus 100 terminates the connection between the electronic apparatus 100 and the control device 200 is because the input source of the electronic apparatus 100 is switched to an external device connected to the first HDMI port of the input/output interface 120.

According to an embodiment of the disclosure, the identification information may refer to data or attributes used to distinguish and recognize between the electronic apparatus 100 and/or the external device 300. The identification information may refer to information including unique characteristics which enable the electronic apparatus 100 and/or the external device 300 to be distinguished from other devices.

For example, the identification information may include at least one of a device name, a medium access control (MAC) address, an Internet Protocol (IP) address, a service set identifier (SSID), a hostname, or an input/output interface of the electronic apparatus 100 to which an external device is connected. For example, when the electronic apparatus 100 transmits a TCR to the control device 200 through the Bluetooth communication protocol, the identification information may include at least one of a device name (e.g., Bluetooth (BT) Friendly Name) or a MAC address. For example, when the electronic apparatus 100 transmits a TCR to the control device 200 through the Wi-Fi communication protocol, the identification information may include, for example, and without limitation, at least one of an SSID, a MAC address, an IP address, a Hostname, a device name, or the like.

For example, when a game console is set as an input source for the electronic apparatus 100, the connection termination reason may be “REASON: CONSOLE CONNECTED”. For example, when a soundbar is set as an input source for the electronic apparatus 100, the connection termination reason may be “REASON: SOUND-BAR CONNECTED”. For example, the identification information may be a name customized for the electronic apparatus 100 and/or external device 300 set by the user. For example, when the user sets a device name of a game console as “MY TOYBOX”, the connection termination reason may be “REASON: MY TOYBOX CONNECTED”.

For example, when two or more external devices 300 of the same type are connected to the electronic apparatus 100, the external devices 300 may be distinguished from each other using the identification information included in the connection termination reason. For example, when two game consoles are connected to the electronic apparatus 100 and the internal source of the electronic apparatus 100 is switched to game console 1, the connection termination reason may be “REASON: CONSOLE1 CONNECTED”. For example, when the internal source of the electronic apparatus 100 is switched to game console 2, the connection termination reason may be “REASON: CONSOLE2 CONNECTED”.

According to an embodiment of the disclosure, the connection termination reason may enable the control device 200, which has received the TCR, to perform a connection operation with the first external device 301 using identification information of the first external device 301 included in the connection termination reason.

According to an embodiment of the disclosure, the control device 200 may receive a TCR transmitted through a TCR packet. A REASON field of the TCR packet may include a connection type reason. The control device 200 may transmit a connection termination response to the electronic apparatus 100 based on the TCR. The control device 200 may receive the TCR from the electronic apparatus 100 and identify the identification information of the first external device 301 included in the connection termination reason.

According to an embodiment of the disclosure, the control device 200 may prepare a connection operation with the first external device 301 based on the identification information of the first external device 301 in a connection sequence. For example, the control device 200 may preferentially proceed with a connection with the first external device 301 recognized through the identification information of the connection termination reason. For example, when the control device 200 includes the first external device 301 in a connection list, which includes a list of devices to which the control device 200 has been connected, the control device 200 may perform a connection operation with the first external device 301 based on the identification information of the first external device 301. For example, when the control device 200 does not include the first external device 301 in a connection list, which includes a list of devices to which the control device 200 has been connected, the control device 200 may perform a pairing and/or connection operation with the first external device 301 based on the identification information of the first external device 301.

For example, when the TCR received by the control device 200 includes the connection termination reason “REASON: CONSOLE CONNECTED”, the control device 200 may preferentially proceed with the connection with “CONSOLE” included in the identification information of the connection termination reason.

The electronic apparatus 100 may, in response to the TCR, receive a connection termination response from the control device 200. According to an embodiment of the disclosure, the connection termination response may include at least one of a message indicating whether the control device 200 has accepted the TCR or whether the termination procedure between the electronic apparatus 100 and the control device 200 has been completed.

In an embodiment of the disclosure, when the electronic apparatus 100 receives the connection termination response from the control device 200, the electronic apparatus 100 may terminate (or release or deactivate) the connection between the electronic apparatus 100 and the control device 200. In an embodiment of the disclosure, when the electronic apparatus 100 receives the connection termination response from the control device 200, the control device 200 may terminate (for example, release or deactivate) the connection between the electronic apparatus 100 and the control device 200.

In an embodiment of the disclosure, the electronic apparatus 100 may update a connection status with the control device 200 and set the connection status as terminated or inactive.

FIG. 6 is a signal flow diagram illustrating an example operating method between an electronic apparatus, a control device, and an external device, according to various embodiments.

Operations included in the flowchart of FIG. 6 may be performed by the electronic apparatus 100 of FIGS. 1, 2, 3, 4 and 5 (which may be referred to as FIGS. 1 to 5). The operations included in the flowchart of FIG. 6 may be included in each operation of FIG. 5. The details described above with reference to FIGS. 1 to 5 may be equally applied to FIG. 6, even when not repeated below.

Referring to FIG. 6, the electronic apparatus 100 may be paired and/or connected with the control device 200, in operation 610. According to an embodiment of the disclosure, the electronic apparatus 100 may be connected with the control device 200 through a communication interface. For example, the electronic apparatus 100 may be connected to the control device 200 through the Bluetooth communication protocol or the Wi-Fi communication protocol.

Referring to operation 620, the electronic apparatus 100 may obtain an input for setting an input source of the electronic apparatus 100 from an internal source of the electronic apparatus 100 to the first external device 301.

Referring to operation 630, the electronic apparatus 100 may transmit a TCR to the control device 200. The TCR transmitted by the electronic apparatus 100 to the control device 200 may be transmitted in response to an input for setting the input source of the electronic apparatus 100 to the first external device 301. The TCR transmitted by the electronic apparatus 100 to the control device 200 may include a connection termination reason including identification information of the first external device. The connection termination reason included in the TCR transmitted by the electronic apparatus 100 may enable the control device 200, which has received the TCR, to perform a connection operation with the first external device 301 using the identification information of the first external device 301 included in the connection termination reason.

Referring to operation 640, the electronic apparatus 100 may receive a connection termination response from the control device 200. According to an embodiment of the disclosure, the electronic apparatus 100 may transmit the TCR to the control device 200. When the electronic apparatus 100 receives the connection termination response, the connection between the electronic apparatus 100 and the control device 200 may be terminated (or released).

Referring to operation 650, the control device 200 may perform a connection operation with the first external device 301. The control device 200 may perform the connection operation with the first external device 301 using the identification information of the first external device 301 included in the connection termination reason included in the TCR received from the electronic apparatus 100.

An example is described in which the electronic apparatus 100 is a TV, the control device 200 is a game pad, and the first external device 301 is a game console. In operation 610, the game pad may be paired and/or connected to the TV. In operation 620, an input may be obtained to switch an input source of the TV from an internal source of the TV to the game console. In operation 630, the TV may transmit a TCR to the game pad. The TCR transmitted by the TV to the game pad may include a connection termination reason including identification information of the game console. The connection termination reason included in the TCR transmitted by the TV may enable the game pad, which has received the TCR, to perform a connection operation with the game console using the identification information of the game console included in the connection termination reason. In operation 640, the game pad may transmit a connection termination response to the TV. In operation 650, the game pad may perform a connection operation with the game console.

FIG. 7 is a signal flow diagram illustrating an example operating method between an electronic apparatus, a control device, and an external device, according to various embodiments.

Referring to FIG. 7, the first external device 301 may be paired and/or connected with the control device 200, in operation 710. According to an embodiment of the disclosure, the first external device 301 may be connected with the control device 200 through a communication interface. According to an embodiment of the disclosure, the first external device 301 may be connected to the control device 200 through the Bluetooth communication protocol or the Wi-Fi communication protocol.

Referring to operation 720, the electronic apparatus 100 may obtain an input for switching the input source of the electronic apparatus 100 from the first external device 301 to an internal source of the electronic apparatus 100. Operation 720 is described in more detail with reference to FIGS. 12 to 14, and any redundant description thereof is omitted here.

Referring to operation 730, the electronic apparatus 100 may transmit, to the first external device 301, a command for instructing to terminate the connection between the first external device 301 and the control device 200. The command transmitted to the first external device 301 from the electronic apparatus 100 so as to indicate to terminate the connection between the first external device 301 and the control device 200 may be transmitted in response to an input for switching the input source of the electronic apparatus 100 from the first external device 301 to the internal source of the electronic apparatus 100. The electronic apparatus 100 may transmit a command for instructing to terminate the connection with the first external device 301, to the first external device 301 through the input/output interface 120 (e.g., the HDMI port 121 or a component jack 122).

Referring to operation 740, the first external device 301 may transmit a TCR to the control device 200. According to an embodiment of the disclosure, the control device 200 may receive the TCR from the first external device 301.

Referring to operation 750, the control device 200 may transmit a connection termination response to the first external device 301. According to an embodiment of the disclosure, the first external device 301 may receive the connection termination response from the control device 200. When the first external device 301 receives the connection termination response, the connection between the first external device 301 and the control device 200 may be terminated (or released).

Referring to operation 760, the electronic apparatus 100 may perform a connection operation with the control device 200. The electronic apparatus 100 and the control device 200 may transmit and receive data to and from each other.

An example is described in which the electronic apparatus 100 is a TV, the control device 200 is a game pad, and the first external device 301 is a game console. In operation 710, the game pad may be paired and/or connected to the game console. In operation 720, an input may be obtained to switch an input source of the TV from the game console to an internal source of the TV. In operation 730, the TV may transmit, to the game console, a command for instructing to terminate the connection with the game pad. In operation 740, the game console may transmit a TCR to the game pad. In operation 750, the game pad may transmit a connection termination response to the game console. In operation 760, the TV may perform a connection operation with the game pad.

FIG. 8 is a signal flow diagram illustrating an example operating method between an electronic apparatus, a control device, and an external device, according to various embodiments.

Because the operations included in the flowchart of FIG. 8 are performed by the electronic apparatus 100 of FIGS. 1, 2, 3, 4, 5, 6 and 7 (which may be referred to as FIGS. 1 to 7), the details described above with reference to FIGS. 1 to 7 may be equally applied to FIG. 9, even when not repeated below.

Referring to FIG. 8, the first external device 301 may be paired and/or connected with the control device 200, in operation 810. Referring to operation 820, the electronic apparatus 100 may obtain an input for switching the input source of the electronic apparatus 100 from the first external device 301 to the electronic apparatus 100. Operation 810 and operation 820 may correspond to operation 710 and operation 720, respectively, and any redundant description may not be repeated here.

Referring to operation 830, the electronic apparatus 100 may transmit, to the first external device 301, a command for instructing to terminate the connection between the first external device 301 and the control device 200. According to an embodiment of the disclosure, the command to terminate the connection between the first external device 301 and the control device 200 may include a second connection termination reason which includes identification information of the internal source of the electronic apparatus 100.

Referring to operation 840, the first external device 301 may transmit a TCR to the control device 200. According to an embodiment of the disclosure, the control device 200 may receive the TCR from the first external device 301. According to an embodiment of the disclosure, the first external device 301, which has received a command for instructing to terminate a connection which includes the second connection termination reason, may transmit a command for instructing to perform a connection operation with the electronic apparatus 100, to the control device 200 using identification information of the internal source of the electronic apparatus 100 included in the connection termination reason.

Referring to operation 850, the control device 200 may transmit a connection termination response to the first external device 301. According to an embodiment of the disclosure, the first external device 301 may receive the connection termination response from the control device 200. Operation 850 may correspond to operation 750, and any redundant description is not repeated here.

Referring to operation 860, the electronic apparatus 100 may perform a connection operation with the control device 200. Operation 860 may be performed in response to operation 840. The electronic apparatus 100 and the control device 200 may transmit and receive data to and from each other.

Operations described with reference to FIG. 8 are described by taking an example in which the electronic apparatus 100 is a TV, the control device 200 is a game pad, and the first external device 301 is a game console. In operation 810, the game pad may be paired and/or connected to the game console. In operation 820, the TV may obtain an input switching an input source of the TV from the game console to an internal source of the TV. In operation 830, the TV may transmit, to the game console, a command for instructing to terminate the connection with the game pad. The command may include the second connection termination reason (e.g., REASON: TV CONNECTED) including the identification information of the internal source of the TV. In operation 840, the game console may transmit a TCR to the game pad. The game console may transmit a command for instructing to perform a connection operation with the TV, to the game pad using the identification information of the internal source of the TV included in the second connection termination reason. In operation 850, the game pad may transmit a connection termination response to the game console. In operation 860, the TV may perform a connection operation with the game pad.

FIG. 9 is a diagram illustrating an example in which an electronic apparatus directly controls a second external device, according to various embodiments.

Because operations included in the reference diagram of FIG. 9 are performed by the electronic apparatus 100 of FIGS. 1, 2, 3, 4, 5, 6, 7 and 8 (which may be referred to as FIGS. 1 to 8), the details described above with reference to FIGS. 1 to 8 may be equally applied to FIG. 9, even when not repeated below.

Referring to FIG. 9, the input source of the electronic apparatus 100 is the second external device 302. That is, the electronic apparatus 100 is displaying content obtained from the second external device 302. When the user presses (e.g., selects) a specific button (or a first button among a plurality of buttons provided on the control device 200) using the control device 200, the control device 200 may transmit a control command corresponding to the specific button (e.g., cancel or terminate) to the electronic apparatus 100. An MBR module 133 of the electronic apparatus 100 may receive a control command from the control device 200 and identify content currently displayed in the electronic apparatus 100. Because the input source of the content currently displayed on the electronic apparatus 100 is the second external device 302, the electronic apparatus may identify that a source to be controlled according to a control command is the second external device 302.

The electronic apparatus 100 may transmit, to the second external device 302, a code signal corresponding to a control command (e.g., cancel) corresponding to the specific button. For example, the MBR module 133 of the electronic apparatus 100 may search a code set corresponding to the second external device 302 to find a code corresponding to the control command (e.g., cancel) corresponding to the specific button, and may transmit the found code signal to an IR blaster 900. The IR blaster 900 may transmit operation control IR corresponding to the received code signal to the second external device 302.

The second external device 302, which has received the operation control IR, may perform the control command (e.g., cancel) corresponding to the specific button according to the received operation control IR, and add an on-screen display (OSD) element to the content currently displayed on the electronic apparatus 100 and provide the content.

In an embodiment of the disclosure, the second external device 302 may be a set-top box, a media streaming device, a digital TV tuner, but is not limited to the examples described. In an embodiment of the disclosure, for convenience of description, an example is described in which a code signal is a control command (e.g., cancel) corresponding to a specific button. However, the disclosure is not limited thereto, and the operation described above may be performed for all control commands corresponding to buttons of the control device 200.

FIG. 10 is a signal flow diagram illustrating an example operating method between an electronic apparatus, a control device, and a second external device, according to various embodiments.

Because operations included in the reference diagram of FIG. 10 are performed by the electronic apparatus 100 of FIGS. 1, 2, 3, 4, 5, 6, 7, 8 and 9 (which may be referred to as FIGS. 1 to 9), the details described above with reference to FIGS. 1 to 9 may be equally applied to FIG. 10, even when not repeated below.

Referring to FIG. 10, the electronic apparatus 100 may be paired and/or connected with the control device 200, in operation 1010. According to an embodiment of the disclosure, the electronic apparatus 100 may be connected to the control device 200 through the Bluetooth communication protocol or the Wi-Fi communication protocol. According to an embodiment of the disclosure, the electronic apparatus 100 may obtain a signal, a command, communication, and/or information through the control device 200.

Referring to operation 1020, the electronic apparatus 100 may obtain an input for setting the input source of the electronic apparatus 100 as the second external device 302. In an embodiment of the disclosure, the electronic apparatus 100 may provide a user interface for setting an input source. According to an embodiment of the disclosure, the electronic apparatus 100 may obtain an input for setting or switching an input source of the electronic apparatus 100, based on a user input received through the UI of the electronic apparatus 100. For example, the setting or switching of the input source of the electronic apparatus 100 may occur through a button click on the control device 200, a touchscreen operation on the electronic apparatus 100, a voice command, or the like. The electronic apparatus 100 may obtain an input for setting the input source of the electronic apparatus 100 to the second external device 302, and switch the input source to the second external device 302 by adjusting an internal setting.

Referring to operation 1030, the electronic apparatus 100 may identify a control code of the second external device 302 corresponding to a signal of the control device 200 operating the electronic apparatus 100. According to an embodiment of the disclosure, the control code may be a unique code corresponding to a specific button input or command of the control device 200. For example, when a button on the control device 200 requests an “OK” function, a control code corresponding to the button may be identified. The electronic apparatus 100 may interpret the signal of the control device 200 and convert the signal into the form of a control code. The electronic apparatus 100 may use the control code to control the second external device 302.

Referring to operation 1040, the electronic apparatus 100 may transmit a signal corresponding to the identified control code to the second external device 302 using, for example, the IR blaster 900. The electronic apparatus 100 may convert the identified control code into an IR signal. The electronic apparatus 100 may transmit the IR signal to the second external device 302 through the IR blaster 900. The IR blaster 900 may be built into the electronic apparatus 100 or may be connected to the electronic apparatus 100 as a separate external device.

In an embodiment of the disclosure, the second external device 302 may include an IR receiver. The second external device 302 may receive the IR signal transmitted from the IR blaster 900 of the electronic apparatus 100. The receiver of the second external device 302 may interpret the received IR signal and recognize a control command corresponding to the signal. Accordingly, the second external device 302 may perform an operation corresponding to the control command.

Referring to an embodiment of the disclosure, while the electronic apparatus 100 maintains the connection with the control device 200, the electronic apparatus 100 may control the second external device 302 using the control device 200 using the IR blaster 900 of the electronic apparatus 100. In this case, the electronic apparatus 100 may continuously maintain a connected state with the control device 200 and may transmit an appropriate control signal to the second external device 302 based on an input provided by the control device 200. Through the above, the control device 200 may indirectly control the second external device 302.

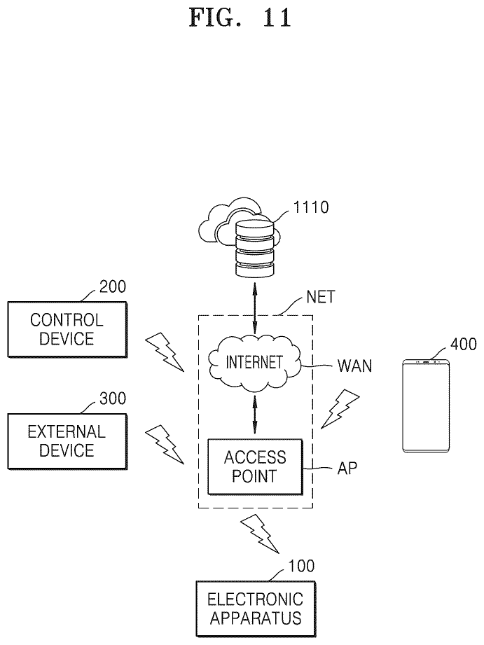

FIG. 11 is a diagram illustrating an example process in which an electronic apparatus, a control device, an external device, and a server perform operations, according to various embodiments.

According to an embodiment of the disclosure, the electronic apparatus 100 may communicate with the control device 200, the external device 300, and a smart device 400 through the communication interface 110 or the input/output interface 120. The electronic apparatus 100 may be connected to the control device 200, the external device 300, the smart device 400, and/or a server 1110.

The server 1110 may manage user account information and information of electronic apparatus 100 connected to the user account. For example, the user may access the server 1110 through the electronic apparatus 100, the external device 300, and/or the smart device 400 and create a user account. The user account may be identified by an ID and password set by the user. The server 1110 may register the electronic apparatus 100 to the user account according to an established procedure. For example, the server 1110 may register the electronic apparatus 100 by associating identification information of the electronic apparatus 100 (e.g., device name, serial number, or MAC address) with the user account.

The smart device 400 may include a communication interface including various communication circuitry for communicating with the electronic apparatus 100 and the server 1110, a user interface for receiving a user input or outputting information to the user, at least one processor for controlling an operation of the smart device 400, and at least one memory for storing at least one instruction for controlling the operation of the smart device 400.

The smart device 400 may be carried by the user or placed in the user's home or office. The smart device 400 may include, but is not limited to, a personal computer, a terminal, a portable telephone, a smartphone, a handheld device, a wearable device, or the like.

The memory of the smart device 400 may store a program (e.g., an application) for controlling the electronic apparatus 100, the control device 200, and/or the external device 300. The smart device 400 may be sold with or without an application installed for controlling the electronic apparatus 100, the control device 200, and/or the external device 300. When the smart device 400 is sold without the application (e.g. application for controlling the electronic apparatus 100, the control device 200 and/or the external device 300) installed, the user may download the application from an external server providing the application and install the downloaded application on the smart device 400.

The user may control the electronic apparatus 100, the control device 200, and/or the external device 300 using the application installed on the smart device 400. For example, when the user executes the application installed on the smart device 400, identification information of the electronic apparatus 100, the control device 200, and/or the external device 300 connected to the same user account as the smart device 400 may appear in an application execution window. The user may perform desired control on the electronic apparatus 100, the control device 200, and/or the external device 300 through the application execution window. When the user inputs a control command for the electronic apparatus 100, the control device 200, and/or the external device 300 through the application execution window, the smart device 400 may directly transmit the control command to the electronic apparatus 100, the control device 200, and/or the external device 300 through a short-range network, or may transmit the control command to the electronic apparatus 100, the control device 200, and/or the external device 300 through the server 1110.

For example, the smart device 400 may transmit, to the server 1110, an input for switching the input source of the electronic apparatus 100 from an internal source of the electronic apparatus 100 to the external device 300. The server 1110 may obtain the input from the smart device 400. The server 1110 may transmit the input from the smart device 400 to the electronic apparatus 100.

The application of the smart device 400 may receive various user inputs for controlling the electronic apparatus 100, the control device 200, and/or the external device 300. The application may provide a Graphical User Interface (GUI) for receiving various user inputs and receive a user input through the GUI. While communicating with the server 1110, the smart device 400 may update state information of an input source of the electronic apparatus 100 and connection information of the control device 200, and provide the updated state information through the application. In addition, while communicating with the server 1110, the electronic apparatus 100 may transmit the user input received through the application to the control device 200 and/or the external device 300.

The application may receive a power-off signal or a termination reservation signal of the electronic apparatus 100 and/or the external device 300. In addition, the application may receive a reservation setting signal and a user input for setting the reservation end time. In addition, the application may receive a connection reservation signal of the control device 200 and/or the external device 300, and receive a user input for setting the reservation end time.

A network (NET) may include both wired and wireless networks. The wired network may include a cable network or a telephone network, and the wireless network may include any network that transmits and receives a signal through radio waves. The wired network and the wireless network may be connected to each other.

The network NET may include a wide area network WAN such as the Internet, a local area network (LAN) formed around an access point AP, and a wireless personal area network (WPAN) which does not pass through the access point. WPAN may include, but is not limited to, Bluetooth™ (IEEE 802.15.1), ZIGBEE (IEEE 802.15.4), Wi-Fi Direct, Near Field Communication (NFC), Z-Wave, or the like.

The access point (AP) may connect LAN to which the electronic apparatus 100, the control device 200, the external device 300, and the smart device 400 are connected to the wide area network WAN to which the server 1110 is connected. The electronic apparatus 100, the control device 200, the external device 300, and the smart device 400 may be connected to the server 1110 through the wide area network (WAN).

The access point (AP) may include a device which enables devices to connect to each other using a standard related to Wi-Fi in a computer network. According to an embodiment of the disclosure, the access point AP may include a hardware-implemented access point and a software-implemented access point.

For example, the access point (AP) may relay data between a wireless device and a wired device on the network. However, the disclosure is not limited thereto, and AP may relay data between wired devices or between wireless devices. Meanwhile, AP may also be referred to as a relay device.

The access point (AP) may communicate with the electronic apparatus 100, the control device 200, the external device 300, or the smart device 400 using wireless communication, such as Wi-Fi™ (IEEE 802.11), and access the wide area network WAN using wired communication.

The electronic apparatus 100 and/or the external device 300 may transmit a TCR including a connection termination reason to the server 1110 through the network (NET). For example, the electronic apparatus 100 and/or the external device 300 may transmit the TCR including the connection termination reason to the server 1110 through Wi-Fi™ (IEEE 802.11) communication. The server 1110 may transmit the TCR to the control device 200.

When the electronic apparatus 100 does not include a Wi-Fi communication module, the electronic apparatus 100 may transmit the TCR including the connection termination reason to the server 1110 through another home appliance having a Wi-Fi communication module. For example, when the electronic apparatus 100 transmits the TCR including the connection termination reason to another home appliance through WPAN (e.g., BLE communication), the other home appliance may transmit the TCR including the connection termination reason of the electronic apparatus 100 to the server 1110. In addition, for example, when the electronic apparatus 100 does not include a Wi-Fi communication module, the electronic apparatus 100 may be connected to a communication relay device via wire to communicate with Wi-Fi communication by the communication relay device.

The electronic apparatus 100 may provide, to the server 1110, the TCR including the connection termination reason obtained by the electronic apparatus 100, according to prior approval by the user. Transmission of information to the server 1110 may be performed when a request is received from the server 1110, when a specific event occurs in the electronic apparatus 100, or periodically or in real time.

When the information about the TCR including the connection termination reason is received from the electronic apparatus 100, the server 1110 may update information previously stored in relation to the electronic apparatus 100. The server 1110 may transmit the information about the TCR including the connection termination reason or a command indicating to terminate the connection, to the electronic apparatus 100 and/nor the external device 300 through the network (NET).

The electronic apparatus 100 may obtain various information from the server 1110 and provide the obtained information to the user. In addition, the electronic apparatus 100 may receive, from the server 1110, a file for updating pre-installed software or data related to pre-installed software, and update the pre-installed software or data related to pre-installed software based on the received file.

The electronic apparatus 100 may operate according to a control command received from the server 1110. For example, when the electronic apparatus 100 obtains prior approval from the user to operate according to the control command from the server 1110 without a user input, the electronic apparatus 100 may operate according to the control command received from the server 1110. The control command received from server 1110 may include, but is not limited to, a control command input by the user through the electronic apparatus 100 or a control command generated by the server 1110 based on a preset condition.

Hereinbelow, an example method by which the electronic apparatus 100 obtains an input for switching an input source of the electronic apparatus 100 from the external device 300 to an internal source of the electronic apparatus 100 is described with reference to FIGS. 12, 13 and 14 (which may be referred to as FIGS. 12 to 14).

FIG. 12 is a diagram illustrating an example process in which an electronic apparatus obtains an input for switching an input source, through a user interface provided by an external device, according to various embodiments.

According to an embodiment of the disclosure, the electronic apparatus 100 and the external device 300 may be connected to each other and may transmit and receive signals to and from each other. When the input source of the electronic apparatus is set as the external device 300, the control device 200 may be connected to the external device 300. In this case, content provided by the external device 300 may be controlled by the control device 200.

According to an embodiment of the disclosure, the electronic apparatus 100 may obtain an input for switching the input source of the electronic apparatus 100, based on a user input received through a UI provided by the external device 300.

Referring to the UI 1210 and the UI 1220, the electronic apparatus 100 may receive a user input through a UI provided by the external device 300.

Referring to the UI 1210, the external device 300 may provide a UI (e.g., a notification screen which states “Do you want to quit game?”) for inquiring whether to terminate the content provided by the external device 300. According to an embodiment of the disclosure, when the external device 300 obtains an intention to terminate the content through a specific button (e.g., a home button) of the control device 200, a UI for inquiring whether to terminate the content provided by the external device 300 may be provided.

When the external device 300 obtains a response (e.g., “OK”) indicating to terminate the content provided by the external device 300, through the UI for inquiring whether to terminate the content provided by the external device 300, the external device 300 may provide a UI 1220 including an option for switching the input source of the electronic apparatus 100. According to an embodiment of the disclosure, the external device 300 may receive, through the control device 200, the user input (e.g., “OK”) for terminating the content provided by the external device 300.

Referring to the UI 1220, the external device 300 may provide a UI (e.g., a notification screen which states “Do you want to switch to TV?”) inquiring whether to switch the input source of the electronic apparatus 100 to the internal source of the electronic apparatus 100. According to an embodiment of the disclosure, the external device 300 may obtain a user response for selecting a response (e.g., “OK”) for switching to the internal source of the electronic apparatus 100 of the UI 1220. According to an embodiment of the disclosure, the external device 300 may obtain, through the control device 200, a user input for selecting a response (e.g., “OK”) for switching from the UI provided by the external device 300 to the internal source of the electronic apparatus 100.

Referring to the UI 1230, the external device 300 may provide a UI for switching input sources, together with the content provided by the external device 300. For example, the external device 300 may provide a menu item 1240, such as “Switch of TV input” or “Go back to TV Mode” on some of an image, audio, and game screens provided by the external device 300. In an embodiment of the disclosure, the external device 300 may receive, through the control device 200, a user input for selecting a UI for switching input sources provided by the external device 300.

According to an embodiment of the disclosure, the electronic apparatus 100 may obtain an input for switching the input source of the electronic apparatus 100, through the input/output interface 120 (e.g., an HDMI port or a PC port) based on the user input received through the UI provided by the external device 300. For example, the electronic apparatus 100 may obtain the input from the external device 300 to switching the input source of the electronic apparatus 100, from the external device 300 based on the user inputs received in the UI 1210 to the UI 1230. Through the above, the electronic apparatus 100 may obtain the input for switching the input source of the electronic apparatus 100, even when the control device 200 is not connected to the electronic apparatus 100.

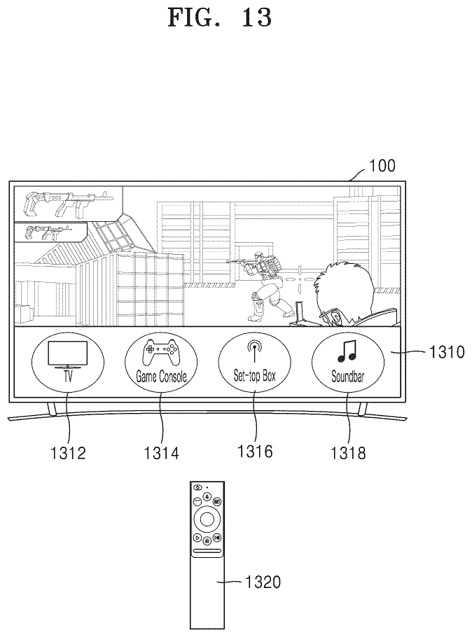

FIG. 13 is a diagram illustrating an example process in which an electronic apparatus obtains an input for switching an input source, through an interface provided by the electronic apparatus, according to various embodiments.

According to an embodiment of the disclosure, when the input source of the electronic apparatus is set as the first external device 301, the control device 200 may be connected to the first external device 301. For example, the control device 200 may not be connected to the electronic apparatus 100.

According to an embodiment of the disclosure, the electronic apparatus 100 may obtain an input for switching the input source of the electronic apparatus 100, through a UI 1310 provided by the electronic apparatus 100 under the control by a remote controller 1320.

For example, when the user presses a specific button on the remote controller 1320 (e.g., External Input, Input Source, or Home button), the electronic apparatus 100 may provide a UI for setting the input source of the electronic apparatus 100. The UI 1310 may include names or icons which indicate input sources (e.g., internal sources of the electronic apparatus 100, the first external device 301, the second external device 302, or the third external device 303). For example, the UI 1310 may include, but is not limited to, an icon 1312 indicating a TV (or an internal source of the TV), an icon 1314 indicating a game console, an icon 1316 indicating a set-top box, and an icon 1318 indicating a soundbar.

When the electronic apparatus 100 provides a UI for setting an input source, the user may select an input source of the electronic apparatus 100 by pressing a specific button on the remote controller 1320 (e.g., up/down/left/right buttons, channel up/down buttons, or volume up/down buttons). Through the above, the input source of the electronic apparatus 100 may be switched.

For example, when the input source of the electronic apparatus 100 is set as the first external device 301, the electronic apparatus 100 may provide the UI 1310 under the control by the remote controller 1320. The electronic apparatus 100 may obtain an input for selecting (or setting or switching) the input source of the electronic apparatus 100 through the UI 1310 provided in the electronic apparatus 100 under the control by the remote controller 1320.

Through the above, the electronic apparatus 100 may obtain the input for switching the input source of the electronic apparatus 100, even when the control device 200 is not connected to the electronic apparatus 100.

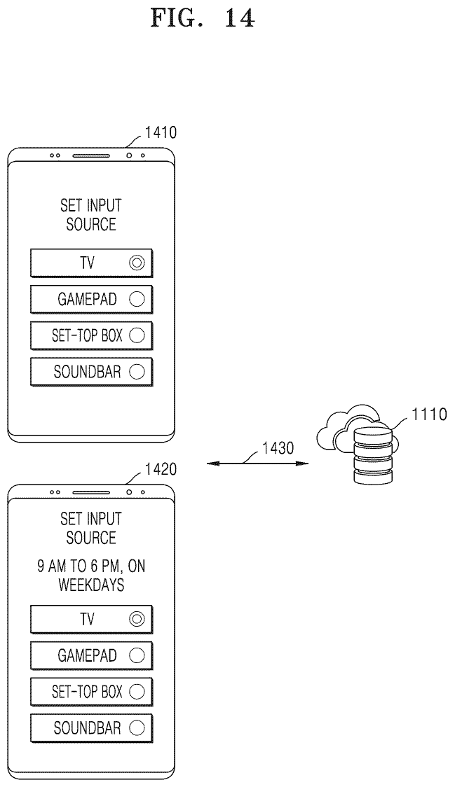

FIG. 14 is a diagram illustrating an example process in which an electronic apparatus obtains an input for switching an input source, from a server which has obtained a user input from a smart device, according to various embodiments.

According to an embodiment of the disclosure, the electronic apparatus 100 may receive an input for switching the input source of the electronic apparatus 100 from the server 1110 which has obtained a user input from the smart device 400.

Referring to the UI 1410, the smart device 400 may obtain the user input for selecting (or setting or switching) the input source of the electronic apparatus 100. For example, the smart device 400 may obtain the input for selecting (or setting or switching) the input source of the electronic apparatus 100 through a button click, a touchscreen operation, or a voice command on the smart device 400.

Referring to the UI 1420, the smart device 400 may obtain a routine (or schedule) for selecting (or setting or switching) the input source of the electronic apparatus 100 as the user input. For example, the smart device 400 may obtain an input for setting the input source of the electronic apparatus 100 to soundbar during “9 AM to 6 PM on weekdays”.

Referring to the communication 1430, the smart device 400 may transmit, to the server 1110, the obtained user input for selecting (or setting or switching) the input source of the electronic apparatus 100. The server 1110 may transmit the user input obtained from the smart device 400 to the electronic apparatus 100. The electronic apparatus 100 may obtain the input for switching the input source of the electronic apparatus 100, from the server 1110 which has obtained the user input from the smart device 400.

According to an embodiment of the disclosure, when the input source of the electronic apparatus is set as the first external device 301, an input for switching the input source of the electronic apparatus 100 to the electronic apparatus 100 may be obtained from the server 1110 which has obtained the user input from the smart device 400. Through the above, the electronic apparatus 100 may obtain an input for switching the input source of the electronic apparatus 100, even when the control device 200 is not connected to the electronic apparatus 100.

According to an embodiment of the disclosure, the at least one instruction, when executed by the at least one processor individually or collectively, may cause the electronic apparatus to, in response to the TCR, receive a connection termination response from the control device.

According to an embodiment of the disclosure, the at least one instruction, when executed by the at least one processor 140 individually or collectively, may cause the electronic apparatus 100 to obtain an input for switching an input source of the electronic apparatus from the first external device to an internal source of the electronic apparatus. According to an embodiment of the disclosure, the at least one instruction, when executed by the at least one processor 140 individually or collectively, may cause the electronic apparatus 100 to transmit, to the first external device in response to the input, a command for instructing to terminate a connection between the first external device and the control device. According to an embodiment of the disclosure, the at least one instruction, when executed by the at least one processor 140 individually or collectively, may cause the electronic apparatus 100 to perform a connection operation with the control device.

According to an embodiment of the disclosure, the command for instructing to terminate the connection between the first external device and the control device may include a second connection termination reason which includes identification information of an internal source of the electronic apparatus. The second connection termination reason may enable the first external device, which has received the command for instructing to terminate the connection, to transmit, to the control device, a command instructing to perform a connection operation with the electronic apparatus, using the identification information of the internal source of the electronic apparatus included in the second connection termination reason.

According to an embodiment of the disclosure, the input for switching the input source of the electronic apparatus may be obtained based on a user input received through a user interface provided by the first external device.

According to an embodiment of the disclosure, the input for switching the input source of the electronic apparatus may be obtained through a UI provided by the electronic apparatus under the control by a remote controller.

According to an embodiment of the disclosure, the input for switching the input source of the electronic apparatus may be received from a server which has obtained a user input from a smart device.

According to an embodiment of the disclosure, the at least one instruction, when executed by the at least one processor individually or collectively, may cause the electronic apparatus to obtain an input for setting the input source of the electronic apparatus as a second external device. According to an embodiment of the disclosure, the at least one instruction, when executed by the at least one processor individually or collectively, may cause the electronic apparatus to, in response to the input, identify a control code of the second external device corresponding to a signal of the control device operating the electronic apparatus. According to an embodiment of the disclosure, the at least one instruction, when executed by the at least one processor individually or collectively, may cause the electronic apparatus to transmit a signal corresponding to the identified control code to the second external device using an IR blaster.

According to an embodiment of the disclosure, the TCR may be transmitted through a TCR packet.

According to an embodiment of the disclosure, the connection termination reason may be included in a REASON field of the TCR packet.

According to an embodiment of the disclosure, the at least one instruction, when executed by the at least one processor individually or collectively, may cause the electronic apparatus to be connected to the control device through the communication interface according to a Bluetooth communication protocol or a Wi-Fi communication protocol.

According to an embodiment of the disclosure, the control device may comprise a game controller.

A method performed by an electronic apparatus, according to an embodiment of the disclosure, may include an operation of receiving a connection termination response from the control device in response to a TCR.

The method performed by the electronic apparatus, according to an embodiment of the disclosure, may include an operation of obtaining an input for switching an input source of the electronic apparatus from the first external device to an internal source of the electronic apparatus. The operation method performed by the electronic apparatus, according to an embodiment of the disclosure, may include an operation of transmitting, to the first external device in response to the input, a command for instructing to terminate a connection between the first external device and the control device. The operation method performed by the electronic apparatus, according to an embodiment of the disclosure, may include an operation of performing a connection operation with the control device.

According to an embodiment of the disclosure, the command for instructing to terminate the connection between the first external device and the control device may include a connection termination reason which includes identification information of an internal source of the electronic apparatus. According to an embodiment of the disclosure, the connection termination reason may enable the first external device, which has received the command for instructing to terminate the connection, to transmit, to the control device, a command for instructing to perform a connection operation with the electronic apparatus, using the identification information of the internal source of the electronic apparatus included in the connection termination reason.

According to an embodiment of the disclosure, the input for switching the input source of the electronic apparatus may be obtained based on a user input received through a user interface provided by the first external device.

According to an embodiment of the disclosure, the input for switching the input source of the electronic apparatus may be obtained through a UI provided by the electronic apparatus under the control by a remote controller. The input for switching the input source of the electronic apparatus may be received from a server which has obtained the user input from a smart device.

The operation method performed by the electronic apparatus, according to an embodiment of the disclosure, may include an operation of obtaining an input for setting the input source of the electronic apparatus as a second external device. The operation method performed by the electronic apparatus, according to an embodiment of the disclosure, may include an operation of identifying, in response to the input, a control code of the second external device corresponding to a signal of the control device operating the electronic apparatus. The operation method performed by the electronic apparatus, according to an embodiment of the disclosure, may include an operation of transmitting a signal corresponding to the identified control code to the second external device using an IR blaster.

According to an embodiment of the disclosure, the TCR may be transmitted through a TCR packet. According to an embodiment of the disclosure, the connection termination reason may be included in a REASON field of the TCR packet.

According to an embodiment of the disclosure, the electronic apparatus may be connected to the control device through the communication interface according to a Bluetooth communication protocol or a Wi-Fi communication protocol.

A machine-readable storage medium may be provided in a form of a non-transitory storage medium. The “non-transitory storage medium” may refer, for example, to a tangible device and may not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment of the disclosure, a method according to various embodiments disclosed in the present disclosure may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or memory of a relay server.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic apparatus comprising:
a communication interface comprising circuitry;
an input/output interface comprising circuitry;
memory storing at least one instruction; and
at least one processor, comprising processing circuitry,
wherein at least one processor individually or collectively, executes the at least one instruction to cause the electronic apparatus to:
wirelessly connect to a control device through the communication interface;
obtain an input for switching an input source of the electronic apparatus from an internal source of the electronic apparatus to a first external device; and
transmit, to the control device wirelessly connected to the electronic apparatus, through the communication interface based on the input, a termination connection request including a connection termination reason including identification information of the first external device, wherein the connection termination reason enables the control device, which has received the termination connection request, to perform a connection operation with the first external device using the identification information of the first external device included in the connection termination reason.

2. The electronic apparatus of claim 1, wherein at least one processor individually or collectively, executes the at least one instruction to cause the electronic apparatus to receive a connection termination response from the control device, in response to the termination connection request.

3. The electronic apparatus of claim 1, wherein at least one processor individually or collectively, executes the at least one instruction to cause the electronic apparatus to:
obtain an input for switching the input source of the electronic apparatus from the first external device to the internal source of the electronic apparatus;
transmit, to the first external device in response to the input, a command for instructing to terminate a connection between the first external device and the control device; and
perform a connection operation with the control device.

4. The electronic apparatus of claim 3, wherein the command for instructing to terminate the connection between the first external device and the control device includes a second connection termination reason including identification information of the internal source of the electronic apparatus, and
the second connection termination reason enables the first external device, which has received the command, to transmit, to the control device, a command instructing to perform a connection operation with the electronic apparatus, using the identification information of the internal source of the electronic apparatus included in the second connection termination reason.

5. The electronic apparatus of claim 3, wherein the input for switching the input source of the electronic apparatus is obtained based on an input received through a user interface provided by the first external device.

6. The electronic apparatus of claim 3, wherein the input for switching the input source of the electronic apparatus is obtained, under control by a remote controller, through the user interface provided by the electronic apparatus.

7. The electronic apparatus of claim 3, wherein the input for switching the input source of the electronic apparatus is received from a server which has obtained the input from a smart device.

8. The electronic apparatus of claim 1, wherein at least one processor individually or collectively, executes the at least one instruction to cause the electronic apparatus to:
obtain an input for setting the input source of the electronic apparatus as a second external device;
identify, in response to the input, a control code of the second external device corresponding to a signal of the control device operating the electronic apparatus; and
transmit a signal corresponding to the identified control code to the second external device using an infrared (IR) blaster.

9. The electronic apparatus of claim 1, wherein the termination connection request is transmitted through a termination connection request (TCR) packet, and
the connection termination reason is included in a REASON field of the TCR packet.

10. The electronic apparatus of claim 1, wherein at least one processor individually or collectively, executes the at least one instruction to cause the electronic apparatus to connect to the control device through the communication interface according to a Bluetooth communication protocol or a Wi-Fi communication protocol.

11. The electronic apparatus of claim 1, wherein the control device comprises a game controller.

12. A method performed by an electronic apparatus, the method comprising:
wirelessly connecting to a control device through a communication interface;
obtaining an input for switching an input source of the electronic apparatus from an internal source of the electronic apparatus to a first external device; and
transmitting, to the control device, connected to the electronic apparatus, based on the input, a termination connection request including a connection termination reason including identification information of the first external device, wherein the connection termination reason enables the control device, which has received the termination connection request, to perform a connection operation with the first external device using the identification information of the first external device included in the connection termination reason.

13. The method of claim 12, further comprising receiving a connection termination response from the control device, in response to the termination connection request.

14. The method of claim 12, further comprising:
obtaining an input for switching the input source of the electronic apparatus from the first external device to the internal source of the electronic apparatus;
transmitting, to the first external device in response to the input, a command for instructing to terminate a connection between the first external device and the control device; and
performing a connection operation with the control device.

15. The method of claim 14, wherein the command for instructing to terminate the connection between the first external device and the control device includes a second connection termination reason including identification information of the internal source of the electronic apparatus, and
the second connection termination reason enables the first external device, which has received the command, to transmit, to the control device, a command instructing to perform a connection operation with the electronic apparatus, using the identification information of the internal source of the electronic apparatus included in the second connection termination reason.

16. The method of claim 14, wherein the input for switching the input source of the electronic apparatus is obtained based on an input received through a user interface provided by the first external device.

17. The method of claim 14, wherein the input for switching the input source of the electronic apparatus is obtained, under control by a remote controller, through the user interface provided by the electronic apparatus.

18. The method of claim 14, wherein the input for switching the input source of the electronic apparatus is received from a server which has obtained the input from a smart device.

19. The method of claim 12, further comprising:
obtaining an input for setting the input source of the electronic apparatus as a second external device;
identifying, in response to the input, a control code of the second external device corresponding to a signal of the control device operating the electronic apparatus; and
transmitting a signal corresponding to the identified control code to the second external device using an infrared (IR) blaster.

20. A non-transitory computer-readable recording medium having recorded thereon a program for performing the method of claim 12, on a computer.
